(19) United States
(12) Patent Application Publication
(10) Pub. No.: US 2025/0253386 A1
(43) Pub. Date: Aug. 7, 2025

(54) COMPLIANCE MEMBERS FOR COMPRESSING ELECTROCHEMICAL CELL STACKS

(71) Applicant: 24M Technologies, Inc., Cambridge, MA (US)

(72) Inventors: Ryan Michael LAWRENCE, Watertown, MA (US); Matthew R. TYLER, New York, NY (US)

(21) Appl. No.: 19/044,982

(22) Filed: Feb. 4, 2025

Related U.S. Application Data
(60) Provisional application No. 63/550,494, filed on Feb. 6, 2024.

(51) Int. Cl. H01M 10/04; H01M 10/38; H01M 50/211

(52) U.S. Cl. CPC H01M 10/0481; H01M 50/211; H01M 10/38

(57) ABSTRACT

An assembly includes a housing defining an internal volume and an electrochemical cell stack including a plurality of electrochemical cells is disposed in the internal volume. A compliance member is disposed in the internal. The compliance member includes a base, and a plurality of biasing members extending from a surface of the. The plurality of biasing members are configured to exert a biasing force on the electrochemical cell stack so as to compress the electrochemical cell stack. A compliance member may additionally, or alternatively be disposed on an electrode stack included in an electrochemical cell and configured to exert a biasing force on the electrode stack.

### CROSS-REFERENCE TO RELATED APPLICATIONS

This application claims priority to and the benefit of U.S. Provisional Application No. 63/550,494, filed Feb. 6, 2024, and entitled “Planar Compliance Members for Compressing Electrochemical Cell Stacks,” the entire disclosure of which is hereby incorporated by reference herein.

### TECHNICAL FIELD

Embodiments described herein are related to systems and methods for applying pressure on an electrochemical cell stack disposed in a housing for compressing the electrochemical cell stack.

### BACKGROUND

Prismatic electrochemical cells such as pouch cells are generally formed into an electrochemical cell stack by disposing multiple such electrochemical cells on top of each other and disposing the electrochemical cell stack into a housing or can. It is desirable to exert a distributed force or pressure on the electrochemical cell stack to compress the electrodes of the electrochemical cells included in the electrochemical cell stack to improve performance and cycle life. Moreover, it may also be desirable to exert pressure on one or more electrodes that may be included in an electrochemical cell such as a prismatic cell. While various methods have been used to apply such a distributed force on conventional electrochemical cell stacks or electrode stack(s) included in electrochemical cells, which include solid electrodes, such conventional technologies are not amenable to compressing electrochemical cell stacks that include electrochemical cells including semi-solid electrodes.

### SUMMARY

Systems, devices, and methods described herein relate to assemblies including electrochemical cell stacks and in particular, to assemblies that include a compliance member disposed or interposed between an electrochemical cell stack that includes a plurality of electrochemical cells, and a sidewall of the housing in which the electrochemical cell stack is disposed. The compliance member is structured or otherwise configured to apply a distributed and uniform pressure on the electrochemical cell stack so as to compress the electrochemical cell stack. The compliance member may be used to exert a pressure on an electrochemical cell stack disposed in the housing, or to exert a pressure on one or more electrodes included in an electrochemical cell that may be disposed in an electrochemical cell stack.

In some embodiments, an assembly includes a housing defining an internal volume; an electrochemical cell stack including a plurality of electrochemical cells disposed in the internal volume; and a compliance member disposed in the internal volume, the compliance member including: a base, and a plurality of biasing members extending away from a surface of the base, the plurality of biasing members configured to cause a biasing force to be exerted on the electrochemical cell stack so as to compress the electrochemical cell stack.

In some embodiments, an assembly includes a housing defining an internal volume; an electrochemical cell stack including a plurality of electrochemical cells disposed in the internal volume, each of the plurality of electrochemical cells including a cathode and an anode, at least one of the cathode or the anode being semisolid; and a compliance member disposed in the internal volume and configured to exert a biasing force on the electrochemical cell stack causing the electrochemical cell stack to transition from an uncompressed configuration before the compliance member is disposed in the internal volume to a compressed state after the compliance member is disposed in the internal volume.

In some embodiments, an assembly includes: a housing defining an internal volume; an electrochemical cell including one or more electrodes disposed in the internal volume; and a compliance member disposed in the internal volume, the compliance member including: a base, and assembly a plurality of biasing members extending away from a surface of the base, the plurality of biasing members configured to cause a biasing force on the one or more electrodes to compress the one or more electrodes.

In some embodiments, a method includes: disposing an electrochemical cell stack including a plurality of electrochemical cells within an internal volume of a housing, each of the plurality of electrochemical cells including a first electrode, a second electrode, and a separator therebetween; disposing a compliance member between an outermost electrochemical cell of the electrochemical cell stack and a sidewall of the housing, the compliance member including a base and a plurality of biasing members coupled thereto, each of the plurality of biasing members configured to exert a biasing force on the base such that the base exerts a pressure on the electrochemical cell stack; and compressing the electrochemical cell stack, via the compliance member, from a first thickness to a second thickness less than the first thickness.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several implementations in accordance with the disclosure and are therefore, not to be considered limiting of its scope, the disclosure will be described with additional specificity and detail through use of the accompanying drawings.

FIG. 1A is schematic illustration of an assembly including an electrochemical cell stack disposed in a housing and a compliance member disposed between the electrochemical cell stack and the housing, according to an embodiment.

FIG. 1B is a block diagram of an electrochemical cell that may be included in the electrochemical cell stack of FIG. 1A, according to an embodiment.

FIG. 2 is a top perspective view a compliance member, according to an embodiment.

FIG. 3A is a top perspective view of a portion of the compliance member of FIG. 2 indicated by the arrow X in FIG. 2; FIG. 3B is a side view of the portion of the compliance member shown in FIG. 3A.

FIG. 4 is a top perspective view of a compliance member in a first configuration, according to an embodiment.

FIG. 5 is a top view of the compliance member of FIG. 4.

FIG. 6 is a top view of a tab included in the compliance member of FIGS. 4-5.

FIG. 7 is a top perspective view of the compliance member of FIG. 4 in a second configuration.

FIGS. 8, 9, and 10 are top perspective views of compliance members, according to various embodiments.

FIG. 11A is a top perspective view of compliance member including 4 tabs, according to an embodiment; FIG. 11B are results from finite element analysis (FEA) of the compliance member of FIG. 11A showing a biasing exerted on a base of the compliance member in response to a 4 lb. biasing force being applied by each tab on the base.

FIG. 12 is an image of an electrochemical cell stack being compressed between two clamping plates, and a compliance member being disposed between the electrochemical cell stack and one of the two clamping plates.

FIG. 13A illustrates the force distribution on a base of the compliance member of FIG. 12 due to biasing force of a plurality of tabs of the compliance member at an initial time after compressing the electrochemical cell stack between the clamping plates; FIG. 13B is a plot of pressure exerted by a base of the compliance member of FIG. 12 on the electrochemical cell stack over a period of 400 seconds; FIG. 14 illustrates the force distribution on the base of the compliance member after a time period of 45 hours after the compliance member is inserted between the electrochemical cell stack and the one of the two clamping plates.

FIG. 15 is a schematic flow chart of a method for exerting a compressive force on an electrochemical cell stack disposed in a housing via a compliance member, according to an embodiment.

Reference is made to the accompanying drawings throughout the following detailed description. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION

Systems, devices, and methods described herein relate to assemblies including electrochemical cell stacks and, in particular, to assemblies that include a compliance member disposed or interposed between an electrochemical cell stack that includes a plurality of electrochemical cells, and a sidewall of the housing in which the electrochemical cell stack is disposed. The compliance member is structured or otherwise configured to apply a distributed and uniform pressure on the electrochemical cell stack so as to compress the electrochemical cell stack. The compliance member may be used to exert a pressure on an electrochemical cell stack disposed in the housing, or to exert a pressure on one or more electrodes included in an electrochemical cell that may be disposed in an electrochemical cell stack.

Prismatic electrochemical cells, such as pouch cells, are generally formed into an electrochemical cell stack by disposing a plurality of such electrochemical cells on top of each other and disposing the electrochemical cell stack into a housing or can. It is desirable to exert a distributed force or pressure on the electrochemical cell stack to compress the electrodes of the electrochemical cell stack to improve performance and cycle life. Various methods have been used to apply such a distributed force on conventional electrochemical cell stacks that include solid electrodes such as: 1) compressing a conventional electrode stack or electrochemical cell stacks just before insertion into a housing such that after insertion, the relaxation of the compressed electrode stack or electrochemical cell stack creates a resultant force between a sidewall of the housing and the electrode stack or electrochemical cell stack; 2) the electrode stack or electrochemical cell stack is inserted into the housing in a dry state (i.e., without electrolyte) such that when electrolyte is added, the separator and active coatings included in such conventional electrochemical cells swell, creating a resultant force between the housing wall and electrochemical cell stack; and 3) restraining hardware is used to compress the one or more cells included in the electrode stack or electrochemical cell stack and apply a distributed load to the electrode stack or electrochemical cell stack.

Such conventional technologies, however, are not amenable to compressing electrochemical cell stacks that include electrochemical cells including semi-solid electrodes. This is because such semi-solid electrodes do not compress like conventional solid electrodes, and the electrolyte is generally added to the electrochemical cells including such semi-solid electrodes before the corresponding electrochemical cell stack is inserted into the housing or can.

On the contrary, embodiments of the compliance member and systems and methods for using such compliance members for exerting a distributed force on an electrochemical cell stack that includes electrochemical cells having semi-solid electrodes, may provide one or more benefits including, for example: (1) facilitating positioning of the compliance member between an electrochemical cell stack and a sidewall of an associated housing by enabling sliding of the compliance member between the electrochemical cell stack and the housing, thereby reducing assembly time and cost; (2) allowing tailoring or adjusting of a magnitude of force or pressure being exerted on the electrochemical cell stack; (3) allowing tailoring or adjusting of force distribution across the compliance member that can advantageously direct a flow of gas build up within the electrochemical cells, or account for various housing shapes; (4) allowing resistance to stress relaxation, thus providing long-term stability; (5) being capable of withstanding thousands of cycles, thus increasing assembly life; (6) having resistance to chemical and electrochemical corrosion; (7) providing a uniform vibration force even during shock and vibration events; and (8) having a simple design that reduces manufacturing time and cost.

As described herein, the term “electrode stack” refers to a stack of electrodes, for example, one or more anodes and one or more cathodes included in an electrochemical cell and disposed on each other.

As described herein, the term “electrochemical cell stack,” refers to a stack of electrochemical cells, that are disposed on top of each other. Each of the electrochemical cell included in the stack may include one or more electrodes (e.g., an electrode stack) and may also include other components such as a separator, and electrolyte contained within a housing, such as a prismatic electrochemical cell, that can be disposed in a prismatic housing. Each of the electrochemical cells may be disposed in their own housing (e.g., a pouch).

It should be appreciated that the concepts described herein related to application of pressure via the compliance member described herein are equally applicable to electrode stacks and electrochemical cell stacks. Therefore, while certain portions of the henceforth disclosure may refer to electrochemical cell stacks, this is not meant to be limited and the same concepts would be equally applicable to electrode stacks, and vice versa. All such concepts are contemplated and should be considered to be within the scope of this disclosure.

In some embodiments, electrodes described herein can include conventional solid electrodes. In some embodiments, the solid electrodes can include binders. In some embodiments, electrodes described herein can include semi-solid electrodes. Semi-solid electrodes described herein can be made: (i) thicker (e.g., greater than 100 μm-up to 2,000 μm or even greater) due to the reduced tortuosity and higher electronic conductivity of the semi-solid electrode, (ii) with higher loadings of active materials, and (iii) with a simplified manufacturing process utilizing less equipment. These relatively thick semi-solid electrodes decrease the volume, mass and cost contributions of inactive components with respect to active components, thereby enhancing the commercial appeal of batteries made with the semi-solid electrodes.

In some embodiments, the semi-solid electrodes described herein are binderless and/or do not use binders that are used in conventional battery manufacturing. Instead, the volume of the electrode normally occupied by binders in conventional electrodes, is now occupied by: 1) electrolyte, which has the effect of decreasing tortuosity and increasing the total salt available for ion diffusion, thereby countering the salt depletion effects typical of thick conventional electrodes when used at high rate, 2) active material, which has the effect of increasing the charge capacity of the battery, or 3) conductive additive, which has the effect of increasing the electronic conductivity of the electrode, thereby countering the high internal impedance of thick conventional electrodes. The reduced tortuosity and a higher electronic conductivity of the semi-solid electrodes described herein, results in superior rate capability and charge capacity of electrochemical cells formed from the semi-solid electrodes. Since the semi-solid electrodes described herein, can be made substantially thicker than conventional electrodes, the ratio of active materials (i.e., the semi-solid cathode and/or anode) to inactive materials (i.e., the current collector and separator) can be much higher in a battery formed from electrochemical cell stacks that include semi-solid electrodes relative to a similar battery formed form electrochemical cell stacks that include conventional electrodes. This substantially increases the overall charge capacity and energy density of a battery that includes the semi-solid electrodes described herein. In some embodiments, the electrodes included in the electrochemical cells described herein may include conventional solid electrodes, for example, electrodes including binders.

In some embodiments, the electrode materials described herein can include a flowable semi-solid or condensed liquid composition. In some embodiments, the electrode materials described herein can be binderless or substantially free of binder. A flowable semi-solid electrode can include a suspension of an electrochemically active material (anodic or cathodic particles or particulates), and optionally an electronically conductive material (e.g., carbon) in a non-aqueous liquid electrolyte. Said another way, the active electrode particles and conductive particles are co-suspended in an electrolyte to produce a semi-solid electrode. Examples of battery architectures utilizing semi-solid electrodes are described in International Patent Publication No. WO 2012/024499, entitled “Stationary, Fluid Redox Electrode,” and International Patent Publication No. WO 2012/088442, entitled “Semi-Solid Filled Battery and Method of Manufacture,” the entire disclosures of which are hereby incorporated by reference.

As used in this specification, the singular forms “a,” “an,” and “the” include plural referents unless the context clearly dictates otherwise. Thus, for example, the term “a member” is intended to mean a single member or a combination of members, “a material” is intended to mean one or more materials, or a combination thereof.

The term “substantially” when used in connection with “cylindrical,” “linear,” and/or other geometric relationships is intended to convey that the structure so defined is nominally cylindrical, linear or the like. As one example, a portion of a support member that is described as being “substantially linear” is intended to convey that, although linearity of the portion is desirable, some non-linearity can occur in a “substantially linear” portion. Such non-linearity can result from manufacturing tolerances, or other practical considerations (such as, for example, the pressure or force applied to the support member). Thus, a geometric construction modified by the term “substantially” includes such geometric properties within a tolerance of plus or minus 5% of the stated geometric construction. For example, a “substantially linear” portion is a portion that defines an axis or center line that is within plus or minus 5% of being linear.

As used herein, the term “set” and “plurality” can refer to multiple features or a singular feature with multiple parts. For example, when referring to a set of electrodes, the set of electrodes can be considered as one electrode with multiple portions, or the set of electrodes can be considered as multiple, distinct electrodes. Additionally, for example, when referring to a plurality of electrochemical cells, the plurality of electrochemical cells can be considered as multiple, distinct electrochemical cells or as one electrochemical cell with multiple portions. Thus, a set of portions or a plurality of portions may include multiple portions that are either continuous or discontinuous from each other. A plurality of particles or a plurality of materials can also be fabricated from multiple items that are produced separately and are later joined together (e.g., via mixing, an adhesive, or any suitable method).

The term “example” as used herein to describe various embodiments or arrangements is intended to indicate that such embodiments or arrangements are possible examples, representations, and/or illustrations of possible embodiments or arrangements (and such term is not intended to connote that such embodiments or arrangements are necessarily crucial, extraordinary, or superlative examples).

The use of “including”, “comprising”, or “having”, “containing”, “involving” and variations thereof herein, is meant to encompass the items listed thereafter as well as, optionally, additional items. In the description the same numerical references refer to similar elements.

As used herein, the term “about” or “generally” or the like in the context of a given value or range (whether direct or indirect, e.g., “generally in line”, “generally aligned”, “generally parallel”, etc.) refers to a value or range that is within 20%, preferably within 10%, and more preferably within 5% of the given value or range.

As used herein, the term “semi-solid” refers to a material that is a mixture of liquid and solid phases, for example, such as a particle suspension, a slurry, a colloidal suspension, an emulsion, a gel, or a micelle.

As used herein, the terms “activated carbon network” and “networked carbon” relate to a general qualitative state of an electrode. For example, an electrode with an activated carbon network (or networked carbon) is such that the carbon particles within the electrode assume an individual particle morphology and arrangement with respect to each other that facilitates electrical contact and electrical conductivity between particles and through the thickness and length of the electrode. Conversely, the terms “unactivated carbon network” and “unnetworked carbon” relate to an electrode wherein the carbon particles either exist as individual particle islands or multi-particle agglomerate islands that may not be sufficiently connected to provide adequate electrical conduction through the electrode.

As used herein, the terms “energy density” and “volumetric energy density” refer to the amount of energy (e.g., MJ) stored in an electrochemical cell per unit volume (e.g., L), including the electrodes, the separator, the electrolyte, the current collectors, and cell packaging. Unless otherwise noted, energy density and volumetric density include cell packaging.

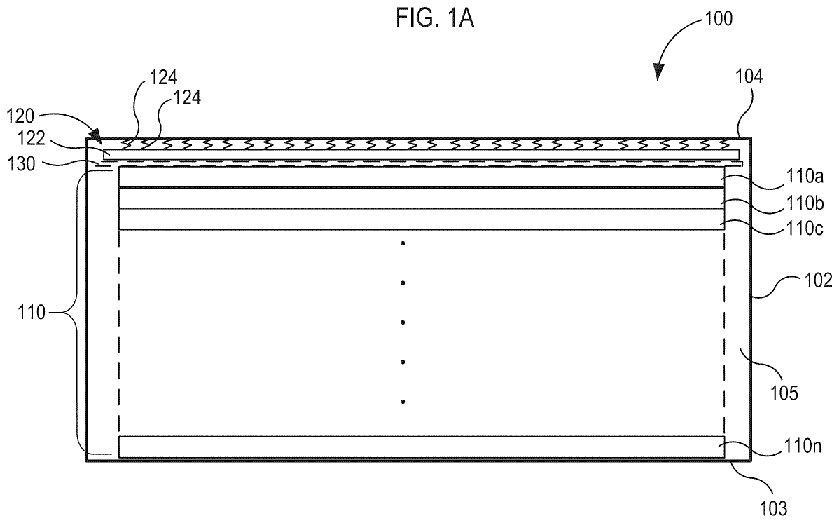

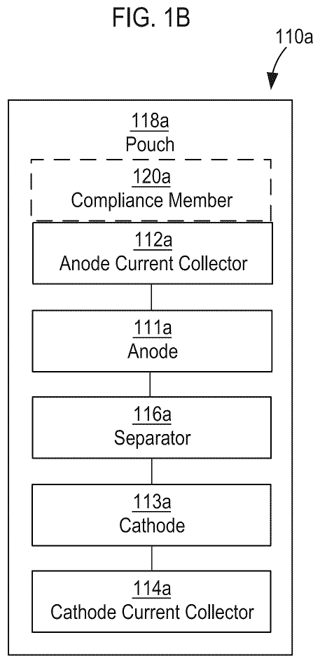

Referring to the figures, FIG. 1A is schematic illustration of an assembly 100 including an electrochemical cell stack 110 disposed in a housing 102, and a compliance member 120, according to an embodiment. The compliance member 120 includes a base 122 and a plurality of biasing members 124 disposed between the electrochemical cell stack 110 (hereinafter “stack 110”) and the housing 102 (e.g., a can). In some embodiments, the assembly 100 may further include an interface sheet 130. As shown in FIG. 1A, the housing 102 defines an internal volume 105 in which the stack 110 is disposed. The stack 110 includes a plurality of electrochemical cells 110a-110n that are stacked on top of one another as they are disposed in the internal volume 105 of the housing 102. For example, the stack 110 may be disposed in the housing 102 such that a first outermost electrochemical cell 110n is disposed on or in contact with (e.g., proximate to) a first sidewall 103 of the housing 102, and a second outermost electrochemical cell 110a is disposed proximate to a second sidewall 104 of the housing 102.

In some embodiments, the compliance member 120 may be disposed between the second outermost electrochemical cell 110a and the second sidewall 104, as described in further detail herein. In some embodiments, a gap may remain between the stack 110 and the second sidewall 104 when the stack 110 is disposed in the internal volume 105 in the uncompressed state. In some embodiments, there is no gap between the stack 110 and the second sidewall 104 when the uncompressed cell stack 110 is disposed in the internal volume, and the compliance member 120 is inserted into the internal volume 105 between the stack 110 and the second sidewall 104 causing biasing members 124 to exert a force on the base 122 and thereby the stack 110 to compress the stack 110, as described herein. In some embodiments, the compliance member 120 may be disposed within the stack 110, for example, between two adjacent electrochemical cells (e.g., any two adjacent cells of the electrochemical cells 110a-110n) included in the stack 110.

The housing 102 can include, or be formed from, a strong and rigid material. In some embodiments, the housing 102 can include, or be formed from, at least one of iron, aluminum, stainless steel, carbon steel, galvanized steel, alloys, plastics, polymers, any other suitable material, or a combination thereof. In some embodiments, the housing 102 may be coated with a corrosion or flame resistant material (e.g., TEFLON®, Nylon, aluminum oxide, titanium oxide, corrosion and/or flame resistance paint, etc.). While FIG. 1A shows the housing 102 as having a substantially rectangular shape, this is for illustrative purposes only and the housing 102 may have any other suitable shape, for example, square, oval, circular, any other suitable shape or a combination thereof.

While shown as including a single compliance member 120, in some embodiments, for example, for a very thick electrochemical cell stack, the assembly 100 may include a plurality of compliance members, each of which may be similar to, or substantially the same as, compliance member 120, and hence may be referred to herein as “compliance members 120”. The compliance members 120 may be disposed at predetermined locations within the housing 102, for example, on a top of the electrochemical cell stack 110, on a bottom of the electrochemical cell stack 110, and at various locations between electrochemical cells 110a-110n included in the stack 110, or between electrodes included in each of the electrochemical cells 110a-110n of the electrochemical cell stack 110. Having multiple compliance members 120 can assist in tailoring an amount of pressure exerted on the electrochemical cell stack 110 (or an electrode stack including one or more anodes, cathodes, and/or separators, and included in one or more of electrochemical cells 110a-110n), and control how much the electrochemical cell stack 110, or electrode stack included in each electrochemical cell 110a-110n, may move during expansion or contraction of the electrochemical cell stack 110 and/or electrode stacks included in each of the electrochemical cells 110a-110n. In some embodiments, a plurality of compliance members 120 can be disposed or stacked in series in the assembly 100 (e.g., stacked on top of each other). In some embodiments, a plurality of compliance members 120 may be disposed or stacked in parallel in the assembly 100 (e.g., side by side). Disposing or stacking the plurality of compliance members 120 in series may serve to reduce a spring constant of the compliance members 120, while stacking in parallel may serve to increase the spring constant. A combination of a plurality of compliance members 120 disposed in series and parallel may be used as well.

In some embodiments, the housing 102 may define an opening at a location thereof that is orthogonal to at least a portion of the first sidewall 103 and/or a portion of the second sidewall 104. For example, as shown in FIG. 1A, the first sidewall 103 may be substantially parallel with the second sidewall 104. In some embodiments, the opening of the housing 102 may be substantially orthogonal to each of the first sidewall 103 and the second sidewall 104, for example, the opening may be facing the observer in FIG. 1A. In some embodiments, the stack 110 may be inserted through the opening into the internal volume 105. The opening may be closed (e.g., using a cap or cover) once the stack 110 has been disposed in the internal volume 105. In some embodiments, the second sidewall 104 may include a cover that is removably coupled to the housing 102. In such embodiments, the stack 110 may be disposed on the first sidewall 103 (e.g., with the first sidewall 103 being oriented downwards with respect to gravity) and the second sidewall 104 (or cover) coupled to the housing 102 to close the housing 102, with the compliance member 120 being disposed between the stack 110 and the second sidewall 104. In some embodiments, the housing 102 may include vents or pressure valves to allow gases that may build up within the internal volume 105 to selectively escape from the housing 102.

FIG. 1B is a schematic block diagram of the electrochemical cell 110a that may be included in the stack 110 of FIG. 1A, according to an embodiment. As shown, the electrochemical cell 110a includes an anode 111a disposed on an anode current collector 112a, a cathode 113a disposed on a cathode current collector 114a, and a separator 116a disposed between the anode 111a and the cathode 113a. The anode 111a, the anode current collector 112a, the cathode 113a, the cathode current collector 114a, and the separator 116a are disposed in a pouch 118a, for example, an aluminum pouch, a mica pouch, a polymer pouch, etc. In some embodiments, the electrochemical cell 110a may optionally include a compliance member 120a.

In some embodiments, each of the electrochemical cell 110a-110n included in the stack 110 of FIG. 1A may be substantially similar to each other. In some embodiments, the compliance member 120a may be similar to, or substantially the same as, the compliance member 120 as described with respect to FIG. 1A. While FIG. 1B shows a particular embodiment of the electrochemical cell 110a that may be included in the stack 110 of FIG. 1A, this is for illustrative purposes only and the stack 110 of FIG. 1A can include any other electrochemical cells having any suitable structure or formulation. All such embodiments are envisioned and should be considered to be within the scope of the present disclosure.

The anode 111a includes an anode active material. In some embodiments, the anode 111a can include an anode conductive material. In some embodiments, the anode 111a can include a semi-solid anode. The anode 111a is disposed on the anode current collector 112a and is configured to communicate electrons thereto and/or receive electrons therefrom. In some embodiments, the anode current collector 112a can include, or be composed of, copper, aluminum, nickel, titanium, any combination thereof, or any other suitable anode current collector material.

The cathode 113a includes a cathode active material. In some embodiments, the cathode 113a can include a cathode conductive material. In some embodiments, the cathode 113a can include a semi-solid cathode. The cathode 113a is disposed on the cathode current collector 114a and is configured to communicate electrons thereto and/or receive electrons therefrom. In some embodiments, the cathode current collector 114a can include, or be formed from, an aluminum or any other suitable current collector material.

The separator 116a can include any suitable separator that acts as an ion-permeable membrane. In other words, the separator 116a allows exchange of ions while maintaining physical separation and/or electrical isolation of the cathode 113a and the anode 111a. For example, the separator 116a can be any conventional membrane that is capable of ion transport. In some embodiments, the separator 116a is a liquid impermeable membrane that permits the transport of ions therethrough, namely a solid or gel ionic conductor. In some embodiments the separator 116a is a porous polymer membrane infused with a liquid electrolyte that allows for the shuttling of ions between the cathode 113a and anode 111a electroactive materials, while preventing the transfer of electrons.

In some embodiments, the separator 116a can be a microporous membrane that prevents particles forming the positive and negative electrode compositions from crossing the membrane. For example, the membrane materials can be selected from polyethylene oxide (PEO) polymer in which a lithium salt is complexed to provide lithium conductivity, or NAFION™ membranes which are proton conductors. For example, PEO based electrolytes can be used as the membrane, which is pinhole-free and a solid ionic conductor, optionally stabilized with other membranes such as glass fiber separators as supporting layers. PEO can also be used as a slurry stabilizer, dispersant, etc. in the positive or negative redox compositions. PEO is stable in contact with typical alkyl carbonate-based electrolytes. This can be especially useful in phosphate-based cell chemistries with cell potential at the positive electrode that is less than about 3.6 V with respect to Li metal. In some embodiments, the separator 116a can include polyethylene, polypropylene, polyimide, or any combination thereof. In some embodiments, the separator 116a can include, or be made from, a ceramic, such as alumina. In some embodiments, the separator 116a can include, or be made from, a suitable polymer with ceramic particles dispersed (e.g., disposed) within the separator 116a and/or deposited on one or both surfaces of the separator 116a.

In some embodiments, pouch 118a can include one or more films, for example, a first and second film that can be coupled to one another, and, in some embodiments, to at least a portion of the separator 116a, to define an internal volume of the pouch 118a, within which components of the electrochemical cell 110a are disposed. While not shown, the electrochemical cell 110a, or any other electrochemical cell included in the stack 110, may include a vent or venting mechanism (e.g., weak sealing regions, piercing mechanisms, etc.) configured to release gases. For example, in some embodiments, gases may build up in the electrochemical cell 110a (e.g., in the pouch 118a) during operation of the electrochemical cell 110a and/or the stack 110, and/or as a result of damage to the electrochemical cell 110a and/or the stack 110, and the vent or venting mechanism may selectively release the gases, or facilitate release of gases (e.g., allow gases to selectively escape), from the electrochemical cell 110a, for example, in response to a gas pressure within the pouch 118a exceeding a predetermined pressure threshold.

Referring again to FIG. 1A, in some embodiments, the plurality of electrochemical cells 110a-110n included in the stack 110 can be connected in parallel. In some embodiments, the plurality of electrochemical cells 110a-110n can be connected in series. In some embodiments, the plurality of electrochemical cells 110a-110n can be disposed in the stack 110 with anodes (e.g., anode 111a) and anode current collectors (e.g., anode current collector 112a) on either terminal end of the stack (i.e., a parallel connection). In some embodiments, the electrochemical cells 110a-110n can be disposed in the stack 110 with cathodes (e.g., cathode 113a) and cathode current collectors (e.g., cathode current collector 114a) on either terminal end of the stack (i.e., a parallel connection).

In some embodiments, each of the plurality of electrochemical cells 110a-110n includes a prismatic cell. In other embodiments, each of the plurality of electrochemical cells 110a-110n may include non-prismatic cells. In some embodiments, the housing 102 may be prismatic such that the assembly 100 is prismatic. As described herein, it is desirable to exert a distributed force across the electrodes (e.g., anode 111a, cathode 113a) of the electrochemical cells (e.g., electrochemical cells 110a-110n), i.e., to compress the electrochemical cells (e.g., electrochemical cells 110a-110n) to improve performance and cycle life. However, the cathode and/or anodes included in the electrochemical cells 110a-110n (e.g., the anode 111a and/or cathode 113a) may include a semi-solid electrode. Conventional electrodes (e.g., solid electrode) used in conventional electrochemical cells are typically formed of solid materials including binders, which may be compressed and infused with electrolyte just prior to being inserted into a conventional housing, but semi-solid electrodes do not compress in the same manner as conventional electrodes. Thus, the electrochemical cells 110a-110n with semi-solid electrodes included in the stack 110 are inserted into the housing 102 in an uncompressed state, and it is desirable to exert a distributed force on the stack 110 once the stack 110 is disposed the internal volume 105 of the housing 102, for example, to compress the plurality of electrochemical cells 110a-110n included in the stack 110 to improve the performance and cycle life thereof.

The anode 111a, the cathode 113a, and the separator 116a included in the electrochemical cell 110a may collectively form an electrode stack. While shown as including one anode 111a and the cathode 113a, the electrode stack of the electrochemical cell 110a and/or the electrode stack can include additional electrodes and/or separators, or any number of electrodes and/or separators, disposed in any suitable configuration. In some embodiments, it may be desirable to exert a pressure directly on the electrode stack, as previously described. Thus, in some embodiments, the compliance member 120a may additionally, or alternatively, be disposed on the electrode stack of the electrochemical cell 110a and configured to exert a pressure thereon. The compliance member 120a may be substantially similar to the compliance member 120 as described with respect to FIG. 1A. In some embodiments, the compliance member 120a may be included in each of the electrochemical cells 110a-110n included in the electrochemical cell stack 110 additionally, or alternatively to the compliance member 120. In some embodiments, only a portion of the electrochemical cells 110a-110n included in the electrochemical cell stack 110 may include the compliance member 120a in addition to, or alternatively to, the compliance member 120.

The compliance member 120 (and/or 120a) is disposed in the internal volume 105, for example, between the stack 110 and the second sidewall 104 of the housing 102 and configured to apply a distributed force on the stack 110 so as to compress the plurality of electrochemical cells 110a-110n. In some embodiments in which the anode 111a and/or the cathode 113a include, or are formed of, semi-solid electrodes or semi-solid materials, the compliance member 120 (and/or 120a) may compress the semi-solid cathode (e.g., cathode 113a include a semi-solid cathode) and/or semi-solid anode (e.g., anode 111a including a semi-solid anode) included in each of the electrochemical cells 110a-110n, thereby improving performance of the electrochemical cells 110a-110n. In other words, the compliance member 120 exerts a biasing force on the stack 110 causing the stack 110 to transition from an uncompressed state (i.e., configuration of stack 110 before the compliance member 120 is disposed in the internal volume 105) to a compressed state (i.e., configuration of stack 110 after the compliance member 120 is disposed in the internal volume 105). The stack 110 may have a first thickness in the uncompressed state which is greater than a second thickness of the stack in the compressed state after being compressed by the biasing force exerted by the compliance member 120. While FIG. 1A shows the compliance member 120 disposed between the second sidewall 104 and the stack 110, the compliance member 120 may be disposed in any other suitable location, for example, between the first sidewall 103 and the stack 110, or within the stack 110, for example, between two adjacent electrochemical cells (e.g., any two adjacent cells of the electrochemical cells 110a-110n) included in the stack 110.

The compliance member 120 can include any suitable structure for exerting a compressive pressure on the stack 110. Suitable structures may include springs, sheet(s) of a compliance material (e.g., polyurethane foam, polyethylene foam, polyester sheets, etc.), or any other biasing material or structure that can apply a compressive force on the stack 110. In some embodiments as shown in FIG. 1A, the compliance member 120 may include the base 122 and the plurality of biasing members 124. At least a portion of the plurality of biasing members 124 may extend from a surface of the base 122 towards at least one of the stack 110 or the second sidewall 104 of the housing 102. The biasing members 124 are configured to exert a biasing force on the stack 110 so as to compress the stack 110 (i.e., the electrochemical cells 110a-110n included in the stack 110).

The base 122 may be substantially planar, for example, include a substantially flat plate configured to be disposed proximate to an outermost electrochemical cell included in the stack 110 (e.g., the electrochemical cell 110a as shown in FIG. 1A). For example, the base 122 may include a sheet formed from a substantially hard and rigid material, for example, iron, steel, stainless steel, tempered steel, aluminum, alloys (e.g., a shape memory alloy such a nitinol), plastics, polymers, any other suitable hard and rigid material, or any suitable combination thereof. In some embodiments, the base 122 may be curved, for example, corresponding to a curvature of the housing 102. In some embodiments, the base 122 (and optionally, the biasing members 124) may be formed from, or coated with, a flame resistant and/or corrosion resistance material (e.g., TEFLON®, Nylon, corrosion and/or flame resistant paint, etc.), for example, to prevent corrosion thereof (e.g., due to leakage of corrosive gases from the electrochemical cells 110a-110n during venting, leakage of electrolyte, and/or in response to one or more of the electrochemical cells catching fire during thermal runaway). The edges of the base 122 may be substantially smoothened (e.g., via grinding, polishing, etc.), and corners of the base 122 may be rounded to inhibit damage to any of the electrochemical cells 110a-110n that the base 122 may contact, for example, when the compliance member 120 is inserted into the housing 102.

In some embodiments, the plurality of biasing members 124 may include springs (e.g., helical springs, Belleville springs, lead springs, any suitable spring or a combination thereof) that are coupled to the base 122 and extend from the base 122 towards the second sidewall 104. The biasing members 124 are configured to contact the second sidewall 104 when the compliance member 120 and configured to exert a compressive force on the base 122 such that the force is distributed over the base 122 and the base 122 exerts a pressure on the stack 110 (e.g., a substantially uniform pressure). In some embodiments, the biasing members 124 may include springs coupled to the second sidewall 104, such that the springs extend from the second sidewall 104 towards the base 122, so as to apply the distributed force on the base 122.

In some embodiments, the plurality of biasing members 124 may extend from a surface of the base 122 towards the second sidewall 104 of the housing 102 and be configured to urge the base 122 towards the stack 110 to compress the stack 110 in response to the biasing members 124 being bent otherwise urged towards the base 122 (e.g., due to contact with the second sidewall 104 and being constrained between the second sidewall 104 and the stack 110). In some embodiments, each of the plurality of biasing members 124 may include a tab (hereinafter “tabs 124”) having a first end coupled to a surface of the base 124 (e.g., a surface that is proximate to the second sidewall 104), and a second end located distal from the first end (e.g., second end may be opposite the first end) and the base 122 such that each of the plurality of tabs 124 are inclined or otherwise bent at a non-zero angle defined between (e.g., measured between) a surface each of the tabs 124 and the surface of the base 122 (or a surface substantially parallel thereto). For example, in some embodiments, each of the plurality of tabs 124 may be inclined or otherwise bent at the non-zero angle relative to (e.g., with respect to) the base 122. In some embodiments, each of the plurality of tabs 124 may be inclined or otherwise bent at the non-zero angle away from the base 122. In some embodiments, the non-zero angle may be in a range of about 5 degrees to about 70 degrees, inclusive (e.g., about 5, about 10, about 15, about 20, about 25, about 30, about 35, about 40, about 45, about 50, about 55, about 60, about 65, or about 70 degrees, inclusive of all values and ranges therebetween). In some embodiments, the non-zero angle may be at least 5 degrees. In some embodiments, the non-zero angle may be at least 10 degrees. In some embodiments, the non-zero angle may be at least 15 degrees. In some embodiments, the non-zero angle may be at least 20 degrees. In some embodiments, the non-zero angle may be at least 25 degrees. In some embodiments, the non-zero angle may be at least 30 degrees. In some embodiments, the non-zero angle may be at most 70 degrees. In some embodiments, non-zero angle may be at most 60 degrees. In some embodiments, non-zero angle may be at most 50 degrees. In some embodiments, non-zero angle may be at most 40 degrees. Various subcombinations of the above ranges are also contemplated (e.g., at least 5 degrees and not more than 70 degrees, or at least 10 degrees and not more than 60 degrees). All such ranges are contemplated and should be considered to be within the scope of the present disclosure.

In some embodiments, each of the plurality of tabs 124 may be coupled to the base 122 (e.g., welded thereto) such that tabs 124 extend at the non-zero angle away from (e.g., relative to) the base 122 towards the second sidewall 104. In some embodiments, the plurality of tabs 124 may be formed monolithically with the base 122. For example, a plurality of slots (e.g., channels, openings, apertures, etc.) may be formed through (e.g., defined in or through) the base 122, for example, via stamping or cutting using any suitable jigs or fixtures, such that a first end of each tab 124 of the plurality of tabs 124 is coupled to the base 122, and a peripheral edge (e.g., defining an outer edge or perimeter) of each tab 124 of the plurality of tabs 124 is disconnected from the base 122. Each of the plurality of tabs 124 may be bent about its respective first end that is still coupled to the base 122 until each of the plurality of tabs 124 is bent or inclined at the desired non-zero angle. In some embodiments, the base 122 and thereby, the tabs 124 may be formed from steel, stainless steel, metals, or alloys, that is heat treated after bending the tabs 124 such that the tabs 124 are in a relaxed state at the non-zero angle orientation, but resist being bent in a direction away from the non-zero angle orientation (e.g., due to an inherent tensile strength of the material from which the base 122 and the tabs 124 are formed). In some embodiments, treating the tabs 124 may include annealing and/or hardening the tabs 124, that may be followed by tempering of the tabs 124.

In some embodiments, the compliance member 120 may be formed such that the tabs 124 are formed in the bent (or curved) configuration during formation of the compliance member 120. For example, the compliance member 120 may be formed using injection molding (e.g., metal injection molding) or via powder metallurgy such that the tabs 124 are formed in their bent or curved configuration during formation of the compliance member 120 and do not have to be bent or curved in a subsequent operation.

In operation, the stack 110 is disposed in the housing 102 in an uncompressed state. In some implementations, a gap or space may exist between an outer most electrochemical cell included in the stack 110 (e.g., the electrochemical cell 110a) and the second sidewall 104 (or conversely the first sidewall 103). In some implementations, the stack 110 may contact each of the opposing first sidewall 103 and the second sidewall 104. The compliance member 120 may subsequently be inserted between the stack 110a and a corresponding sidewall (e.g., the second sidewall 104) of the housing 102, for example, by sliding the compliance member 120 between the stack and the second sidewall 104 (e.g., in the gap or space between the stack and the second sidewall 104) in an orientation in which of the plurality of tabs 124 is inclined away from an edge of the opening of the housing 102 through which the compliance member 120 is inserted into the housing 102. Because no gap exists between the stack 110 and the second sidewall 104, or if the gap exists, the gap may be smaller than an axial height of each of the tabs 124 measured from the base 122 to the axial edge of each of the tabs 124 that is distal from the base 122, the insertion of the compliance member 120 into the housing 102 causes the plurality of tabs 124 to bend towards the base 122 due to contact with the second sidewall 104. This causes the plurality of tabs 124 to exert a biasing force on the base 120. Since the base 122 may be substantially planar, the individual biasing force exerted by the plurality of tabs 124 is distributed across the base 122 to cause the base 122 to exert a pressure (e.g., a substantially uniform pressure) on the stack 110 and thereby, compress the stack 110.

Because the compliance member 120 is oriented when inserting into the housing 102 such that plurality of tabs 124 are inclined away from an edge of the opening of the housing 102, or alternately towards the edge of the opening of the housing 102, through which the compliance member 120 is inserted thereinto, a flat inclined surface of each of the plurality of tabs 124 contacts the edge of the housing 102 as the compliance member 120 is slid (e.g., axially slid) or otherwise inserted into the housing 102. The flat inclined surface of each of the plurality of tabs 124 serves as a ramp facilitating smooth insertion of the compliance member 120 while reducing friction, as well serving to gradually increasing the force applied by the edge and subsequently, the second sidewall 104 on each of the plurality of tabs. This causes each of the plurality of tabs 124 to bend about their respective first ends towards the base 122. Each of the plurality of tabs 124 can have a flexural modulus such that flexing or bending of the plurality of tabs 124 causes each of the plurality of tabs 124 to exert an opposing axial force on the base 122, which may be substantially flat. The opposing axial force of each of the plurality of tabs 124 may be distributed over the base 122 such that the base 122 exerts the pressure across its area on the stack 110 and in this manner, causes compression of the stack 110.

The compliance member 120 (or multiple compliance members 120) may be disposed in the housing 102 in any suitable configuration or order. In some embodiments, the components of the assembly 100 may be disposed through a top of the housing 102. For example, the second sidewall 104 may include a cover that is detached from the housing 102. The electrochemical cell stack 110 may be disposed in the housing 102 and the compliance member 120 disposed thereon (for example, with the interface sheet 130 disposed therebetween, as described herein) in an unrestrained state. The second sidewall 104 may then be disposed on the housing 102 and pressed or urged towards the compliance member 120 to cause the compliance member 120 to be restrained and exert the compressive force on the electrochemical cell stack 110 or electrode stack included in each electrochemical cell 110a-110n. The second sidewall 104 may then be secured (e.g., welded, or secured using fasteners and/or a snap fit mechanism) to the housing 102 to maintain the load (e.g., compressive force) on the compliance member 120. In some embodiments, the housing 102 may define an opening in a face thereof, for example, a largest face of the housing 102, through which the components of the assembly 100 are inserted into the internal volume of the housing 102 in an unrestrained state. In such embodiments, the second sidewall 104 (e.g., a cover) of the housing 102 may be movable, and may be compressed down to compress the plurality of tabs 124 to exert a desired load (e.g., compressive force) on the electrochemical cell stack 110, or electrode stack included in the electrochemical cells 110a-110n. Once a desired compressive load is achieved on the electrochemical cell stack 110 or electrode stack(s), the side wall 104 may be secured to the housing 102 to maintain the load on the compliance member 120. In some embodiments, insertion of the compliance member 120 into the housing 102 may cause the plurality of tabs 124 to bend, thus causing the compliance member 120 to exert a compressive force on the electrochemical cell stack 110 or electrode stacks, as previously described herein.

In some embodiments, the interface sheet 130 may be interposed between the compliance member 120 and the stack 110. The interface sheet 130 may be configured to prevent the base 122 from contacting the outermost electrochemical cell of the stack 110 (e.g., the electrochemical cell 110a) as the compliance member 120 is inserted into the housing 102. In this manner, the interface sheet 130 may prevent the outermost electrochemical cell (e.g., electrochemical cell 110a) of the stack 110 (e.g., or a pouch thereof, such as the pouch 118a) from getting damaged by an edge of the base 122 contacting and sliding against the pouch (e.g., the pouch 118a) of the outermost electrochemical cell that may damage the or rupture the pouch. In some embodiments, the interface sheet 130 may include a sheet of metal, plastic, polymers (e.g., polyethylene terephthalate, polytetrafluoroethylene, etc.) paper, silicone, foams (e.g. polyethylene, polypropylene, polyurethane, etc.), or any other suitable material, or any suitable combination thereof. In some embodiments, the interface sheet 130 may be formed from, or coated with a corrosion resistance and/or fire resistance material, as described herein. In some embodiments, the edges of the base 122 may be substantially smoothened (e.g., via grinding, polishing, etc.), and corners of the base 122 may be rounded to inhibit damage to any of the electrochemical cells 110a-110n that the base 122 may contact when the compliance member 120 is inserted into the housing 102. In some embodiments, the interface sheet 130 may be inserted into the housing 102 prior to the compliance member 120 being inserted into the housing 102. In some embodiments, the interface sheet 130 and the compliance member 120 may be inserted simultaneously into the housing 102, for example, to inhibit any damage to any of the electrochemical cells 110a-110n included in the stack 110.

Thus, each of the plurality of tabs 124 are inclined about the first end at the non-zero angle away from the base 122 and configured to exert a biasing force on the base 122 in response to being bent towards the base 122. In other words, each of the plurality of tabs 124 acts like a spring biasing the base 122 towards the stack 110 thereby, compressing the stack 110. The amount of biasing force exerted by the compliance member 120 may depend on the number of tabs 124, the size of the tabs 124, the amount of bending being experienced by the tabs 124, and/or the size of the base 122. In some embodiments, the amount of force exerted by each tab 124 may be proportional to a width of each tab 124 at the first end thereof where the respective tab is coupled to the base 122 (i.e., about which each tab 124 is bent), and the length of the tab 124 measured from the first end to the second end of the tab 124 opposite the first end, which is located distal from the base 122 in an initial configuration of the compliance member 120 (i.e., when the tabs 124 are bent at non-zero angle about the first end).

In some embodiments, the number of tabs 124 included in the compliance member 120 may be in a range of 3 tabs to 10,000 tabs, inclusive of all values and ranges therebetween, or an even larger number of tabs (e.g., for very large electrochemical cells having a surface area of 1 meter or larger). In some embodiments, the number of tabs 124 included in the compliance member 120 may be in a range of 51 tabs to 201 tabs, inclusive. In some embodiments, the number of tabs 124 included in the compliance member 120 may be 59. In some embodiments, the number of tabs 124 included in the compliance member 120 may be 111. In some embodiments, the number of tabs 124 included in the compliance member 120 may be 157. In some embodiments, multiple rows of the plurality of tabs 124 may be provided on the base 122 with each row including the same number of tabs 124. In some embodiments, a first row of the plurality of tabs 124 may include an even number of tabs 124, a second row of the plurality of tabs 124 adjacent to the first row may include an odd number of tabs 124, a third row of the second row of the plurality of tabs 124 adjacent to the second row may include an even number of tabs 124, and so on and so forth. In some embodiments, a first row of the plurality of tabs 124 may include an odd number of tabs 124, a second row of the plurality of tabs 124 adjacent to the first row may include an even number of tabs 124, a third row of the second row of the plurality of tabs 124 adjacent to the second row may include an odd number of tabs 124, and so on and so forth. In some embodiments, the rows including the odd number of tabs 124 may include more tabs 124 relative to the rows including the even number of tabs 124 (e.g., one more tab 124). In some embodiments, the rows including the odd number of tabs 124 may include less tabs 124 relative to the rows including the even number of tabs 124 (e.g., one less tab 124).

In some embodiments, a length of each of the plurality of tabs 124 measured from a first edge (e.g., at or proximate to the first end) to a second edge (e.g., at or proximate to the second end) may be in a range of about 3 mm to about 50 mm, inclusive (e.g., about 3, about 4, about 5, about 6, about 7, about 8, about 9, about 10, about 11, about 12, about 13, about 14, about 15, about 16, about 17, about 18, about 19, about 20, about 25, about 30, about 35, about 40, about 45, or about 50 mm, inclusive of all values and ranges therebetween). In some embodiments, a width of each of the plurality of tabs 124 may be in a range of about 1 mm to about 10 mm, inclusive (e.g., about 1, about 2, about 3, about 4, about 5, about 6, about 7, about 8, about 9, or about 10 mm, inclusive of all values and ranges therebetween). In some embodiments, the length of each of the plurality of tabs 124 may be greater than a corresponding width of each of the plurality of tabs 124. In some embodiments, the length of each of the plurality of tabs 124 may be less than a corresponding width of each of the plurality of tabs 124. In some embodiments, a ratio of the length to the width of each of the plurality of tabs 124 may be in a range of about 10:1 to about 0.5:1, inclusive (e.g., about 10:1, about 9:1, about 8:1, about 7:1, about 6:1, about 5:1, about 4.5:1, about 4:1, about 3.5:1, about 3:1, about 2.5:1, about 2:1, about 1.5:1, about 1:1, or about 0.5:1, inclusive of all values and ranges therebetween).

In some embodiments, each of the plurality of tabs 124 may be configured to apply a biasing force on the stack 110 and/or the base 122 that may be in a range of about 0.1 lbs. to about 50 lbs. (i.e., pound-force (lbf)), inclusive (e.g., about 0.1, about 0.5, about 1, about 1.5, about 2.0, about 2.5, about 3.0, about 3.5, about 4.0, about 4.5, about 5.0, about 10, about 15, about 20, about 25, about 30, about 35, about 40, about 45, or about 50 lbs., inclusive of all values and ranges therebetween). In some embodiments, the higher the number of tabs 124 included in the compliance member 120, the lower the force exerted by each of the plurality of tabs 124 on the base 122 to cause the base 122 to exert the desired biasing pressure on the stack 110. In some embodiments, the compliance member 120 may be configured to exert a pressure in a range of about 1.0 psi to about 100.0 psi, inclusive on the stack 110 (e.g., about 1.0, about 2.0, about 2.5, about 3.0, about 3.5, about 4.0, about 4.5, about 5.0, about 6.0, about 7.0, about 8.0, about 9.0, about 10.0, about 11.0, about 12.0, about 13.0, about 14.0, about 15.0, about 20.0, about 30.0, about 40.0, about 50.0, about 60.0, about 70.0, about 80.0, about 90.0, or about 100.0 psi, inclusive of all values and ranges therebetween) irrespective of the number of tabs 124 included in the compliance member 120.

In some embodiments, the pressure exerted by the compliance member 120 is at least about 1.0 psi. In some embodiments, the pressure exerted by the compliance member 120 is at least about 2.0 psi. In some embodiments, the pressure exerted by the compliance member 120 is at least about 2.5 psi. In some embodiments, the pressure exerted by the compliance member 120 is at least about 3.0 psi. In some embodiments, the pressure exerted by the compliance member 120 is at least about 3.5 psi. In some embodiments, the pressure exerted by the compliance member 120 is at least about 4.0 psi. In some embodiments, the pressure exerted by the compliance member 120 is at least about 4.5 psi. In some embodiments, the pressure exerted by the compliance member 120 is at least about 5.0 psi. In some embodiments, the pressure exerted by the compliance member 120 is at least about 6.0 psi. In some embodiments, the pressure exerted by the compliance member 120 is at least about 7.0 psi. In some embodiments, the pressure exerted by the compliance member 120 is at least about 8.0 psi. In some embodiments, the pressure exerted by the compliance member 120 is at least about 9.0 psi. In some embodiments, the pressure exerted by the compliance member 120 is at least about 10.0 psi. In some embodiments, the pressure exerted by the compliance member 120 is at least about 11.0 psi. In some embodiments, the pressure exerted by the compliance member 120 is at least about 12.0 psi. In some embodiments, the pressure exerted by the compliance member 120 is at least about 15.0 psi. In some embodiments, the pressure exerted by the compliance member 120 is at least about 20.0 psi. In some embodiments, the pressure exerted by the compliance member 120 is at least about 30.0 psi. In some embodiments, the pressure exerted by the compliance member 120 is at least about 40.0 psi. In some embodiments, the pressure exerted by the compliance member 120 is at least about 50.0 psi.

In some embodiments, the pressure exerted by the compliance member 120 is at most about 100.0 psi. In some embodiments, the pressure exerted by the compliance member 120 is at most about 90.0 psi. In some embodiments, the pressure exerted by the compliance member 120 is at most about 80.0 psi. In some embodiments, the pressure exerted by the compliance member 120 is at most about 70.0 psi. In some embodiments, the pressure exerted by the compliance member 120 is at most about 60.0 psi. In some embodiments, the pressure exerted by the compliance member 120 is at most about 50.0 psi. In some embodiments, the pressure exerted by the compliance member 120 is at most about 40.0 psi. In some embodiments, the pressure exerted by the compliance member 120 is at most about 35.0 psi. In some embodiments, the pressure exerted by the compliance member 120 is at most about 30.0 psi. In some embodiments, the pressure exerted by the compliance member 120 is at most about 25.0 psi. In some embodiments, the pressure exerted by the compliance member 120 is at most about 20.0 psi.

In some embodiments, each of the plurality of tabs 124 may be substantially straight from the first end to the corresponding second end that is located distal from the base 122 in an initial unbent configuration of each of the plurality of tabs 124 (i.e., before insertion into the housing 102). In some embodiments, the second end of each of the plurality of tabs 124 is squared (e.g., having a substantially flat or planar edge). In some embodiments, the second end of each of the plurality of tabs 124 is rounded so as to have a radius of curvature in a range of about 1 mm to about 25 mm, inclusive (e.g., about 1, about 2, about 3, about 4, about 5, about 6, about 7, about 8, about 9, about 10, about 15, about 20, or about 25 mm, inclusive of all values and ranges therebetween). In some embodiments, the radius of curvature may be at least about 1 mm. In some embodiments, the radius of curvature may be at least about 2 mm. In some embodiments, the radius of curvature may be at least about 3 mm. In some embodiments, the radius of curvature may be at least about 4 mm. In some embodiments, the radius of curvature may be at least about 5 mm. In some embodiments, the radius of curvature may be at least about 6 mm. In some embodiments, the radius of curvature may be at least about 7 mm. In some embodiments, the radius of curvature may be at least about 8 mm. In some embodiments, the radius of curvature may be at most about 25 mm. In some embodiments, the radius of curvature may be at most about 20 mm. In some embodiments, the radius of curvature may be at most about 15 mm. In some embodiments, the radius of curvature may be at most about 10 mm. In some embodiments, the radius of curvature may be at most about 5 mm. In some embodiments, the second end of each of the plurality of tabs 124 is chamfered.

In some embodiments, each of the plurality of tabs 124 may have one or more additional bends or ridges (e.g., inflection regions) along its length from the first edge to the second edge in the initial unbent configuration of each of the plurality of tabs 124. For example, in some embodiments, each of the plurality of tabs 124 may include the first end or first edge coupled to the surface of the base 122, the second end or second edge located distal from the first end and the base 122, and a ridge formed in the each of the plurality of tabs 124 at location between the first end (or first edge) and the second end (or second edge). Thus, in some embodiments, the non-zero angle may be a first non-zero angle, a first portion of each of the tabs 124 defined at the first non-zero angle relative to the base 122 (or a surface parallel thereto), and each of the tabs 124 may include a second portion defined at a second non-zero angle, for example, relative to the base 122 (or a surface parallel thereto). In some embodiments, the second non-zero angle may be similar to the first non-zero angle. In some embodiments, the second non-zero angle may be different from the first non-zero angle.

In some embodiments, the first portion of each of the tabs 124 may include a first surface (or a first portion of the surface), and the first non-zero angle may be defined between the first surface (or first portion of the surface) and the base 122. Likewise, in some embodiments, the second portion of each of the tabs 124 may include a second surface (or a second portion of the surface), and the second non-zero angle may be defined between the second surface (or second portion of the surface) and the base 122. In some embodiments, the first portion of each of the tabs may be defined from the first end of each of the tabs 124 to the ridge. In some embodiments, the second portion of each of the tabs may be defined from the ridge to the second end of each of the tabs 124.

In some embodiments, each of the plurality of tabs 124 may extend at the first non-zero angle from the first end to the ridge away from the base 122, and each of the plurality of tabs 124 are bent about the ridge to extend at the second non-zero angle towards the base 122. In other words, each of the plurality of tabs 124 may be inclined away from the base 122 from the first end towards the ridge, and inclined towards the base 122 from the ridge to the second end thereof such that a first axial distance measured from the base 122 to the ridge is greater than a second axial distance measured from base 122 to the second end. Thus, when the compliance member 120 is inserted into the housing 102, the ridge contacts the second sidewall 104 causing a corresponding tab 124 to bend towards the base 122 and exert a force on the base 122, and thereby a pressure on the stack 110. The ridge may provide a smoother surface for contacting the edge of the opening of the housing 102 through which the compliance member 120 is inserted, and for contacting the second sidewall 104 and slide thereacross as the compliance member 120 is inserted into the housing 102. This may facilitate insertion of the compliance member 120 into the housing 102 by reducing resistance encountered between the compliance member 120 and the housing 102 due to friction between the edge and/or second sidewall 104 and the ridge because of the smoother profile of the ridge relative to a sharp edge. In some embodiments, each of the plurality of tabs 124 may include a plurality of bends or ridges along its length, for example, two or more bends or ridges. In some embodiments, instead of having one or more bends, or in addition to having one or more bends, the plurality of tabs 124, or at least a portion of the plurality of tabs may define a continuous curvature. This may provide the advantage of allowing a spring constant of the plurality of tabs 124 to be tailored as desired. In some embodiments, each the plurality of tabs 124 may have the about equal spring constant along their length. In other embodiments, the spring constant of at least a portion of the plurality of tabs 124 may vary across a length thereof.

In some embodiments, each of the plurality of tabs 124 are bent about the ridge so as to extend at the second non-zero angle, which may be away from the base 122. In such embodiments, the second non-zero angle may be greater than the first non-zero angle, and a first axial distance measured from the base 122 to the ridge may be less than a second axial distance measured from base 122 to the second end.

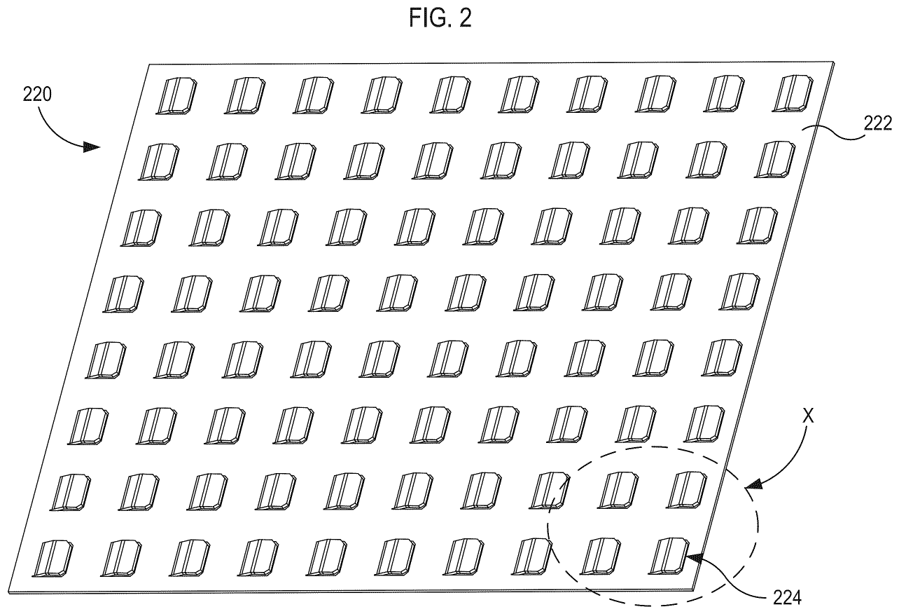

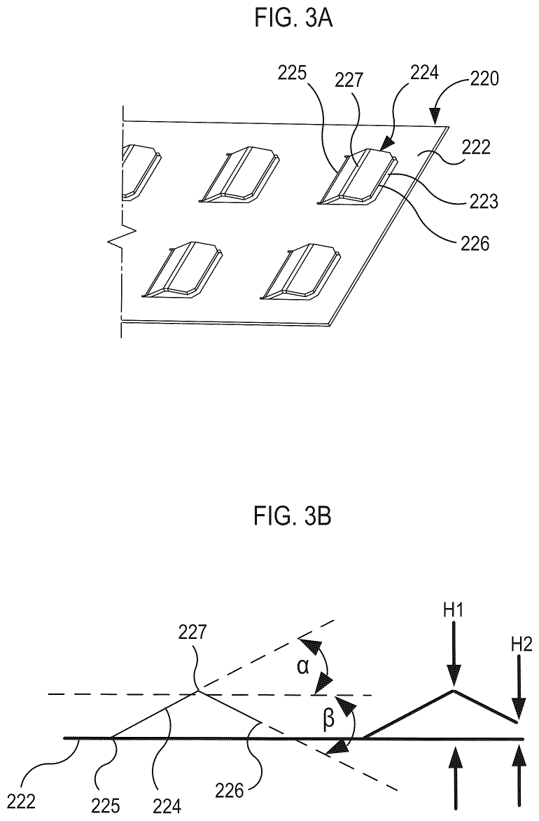

FIG. 2 is a top perspective view a compliance member 220, according to an embodiment. The compliance member 220 includes a base 222, and a plurality of tabs 224 extending from a surface of the base 222. The base 222 includes a planar member. In some embodiments, the compliance member 220, the base 222, and/or the tabs 224 may be substantially similar to the base 122, and/or the tabs 124, respectively, as described with respect to FIG. 1A. Therefore, certain features of the compliance member 220, the base 222, and/or the tabs 224 are not described in further detail herein. FIG. 3A is a top perspective view of a portion of the compliance member 220 including several of the plurality of tabs 224 of FIG. 2 encircled by a dashed line and indicated by an arrow X in FIG. 2. FIG. 3B is a side view of the tabs 224 included in the portion of the compliance member 220 shown in FIG. 3A. Each of the plurality of tabs 224 are formed by forming slots 223 in the base 222 and bending the tabs 224 about a first end 225 thereof.

As shown in FIGS. 3A and 3B, each of the plurality of tabs 224 includes a first end 225 (or first edge) coupled to the surface of the base 222 and a second end 226 (or second edge) located distal from the first end 225 and the base 222. A ridge 227 is formed in the each of the plurality of tabs 224 at a location between the first end 225 the second end 226 such that each of the plurality of tabs 224 extends at a first angle α from the first end 225 to the ridge 227 away from the base 222 and the plurality of tabs 224 are bent about the ridge 227 at a second angle β towards the base 222. In some embodiments, the first angle α is in a range of about 5 degrees to about 70 degrees, inclusive (e.g., about 5, about 10, about 15, about 20, about 25, about 30, about 35, about 40, about 45, about 50, about 55, about 60, about 65, or about 70 degrees, inclusive of all values and ranges therebetween). In some embodiments, the second angle β is in a range of about 5 degrees to about 70 degrees, inclusive (e.g., about 5, about 10, about 15, about 20, about 25, about 30, about 35, about 40, about 45, about 50 about, 55, about 60, about 65, or about 70 degrees, inclusive of all values and ranges therebetween). In some embodiments, the first angle α is about equal to the second angle β. In some embodiments, the first angle α is different from the second angle β.

The orientation of the first angle α and the second angle β may cause a first axial distance or height H1 measured from the base 222 to the ridge 227 to be greater than a second axial distance or height H2 measured from base 222 to the second end 226. In some embodiments, the first axial distance H1 may in a range of about 1 mm to about 45 mm, inclusive, and the second axial distance H2 may be in a range of about 0 mm to about 45 mm, inclusive. As previously described herein, the ridge 227 may provide a smoother surface for contacting an edge of an opening of a housing (e.g., the housing 102) through which the compliance member 220 is inserted, and contacting a corresponding sidewall (e.g., the second sidewall 104) and slide thereacross as the compliance member 220 is inserted into the housing, e.g., to facilitate insertion of the compliance member 220 into the housing.

While FIG. 2 shows the compliance member 220 as including 80 tabs 224, in some embodiments, the compliance member 220 may include any number of tabs 224, for example, in a range of 3 tabs to 10,000 tabs, inclusive. In some embodiments, multiple rows of the plurality of tabs 224 may be provided on the base 222 with each row including the same number of tabs 224, and each row including an even number of tabs 224, as shown in FIG. 2. In some embodiments, each of row of the compliance member 220 may include an odd number of tabs 224. In some embodiments, a first row of the plurality of tabs 224 may include an even number of tabs 224, a second row of the plurality of tabs 224 adjacent to the first row may include an odd number of tabs 224, a third row of the second row of the plurality of tabs 224 adjacent to the second row may include an even number of tabs 124, and so on and so forth. In some embodiments, a first row of the plurality of tabs 224 may include an odd number of tabs 224, a second row of the plurality of tabs 224 adjacent to the first row may include an even number of tabs 224, a third row of the second row of the plurality of tabs 224 adjacent to the second row may include an odd number of tabs 124, and so on and so forth. In some embodiments, the rows including the odd number of tabs 224 may include more tabs 224 relative to the rows including the even number of tabs 224 (e.g., one more tab 224). In some embodiments, the rows including the odd number of tabs 224 may include less tabs 224 relative to the rows including the even number of tabs 224 (e.g., one less tab 224).

In some embodiments, a peripheral length of each of the plurality of tabs 224 measured from the first end 225 to the second end 226 may be in a range of about 3 mm to about 50 mm, inclusive (e.g., about 3, about 4, about 5, about 6, about 7, about 8, about 9, about 10, about 11, about 12, about 13, about 14, about 15, about 16, about 17, about 18, about 19, about 20, about 25, about 30, about 35, about 40, about, or about 50 mm, inclusive of all values and ranges therebetween). In some embodiments, a width of each of the plurality of tabs 224 may be in a range of about 1 mm to about 25 mm, inclusive (e.g., about 1, about 2, about 3, about 4, about 5, about 6, about 7, about 8, about 9, about 10 mm, about 15, about 20, or about 25 mm, inclusive of all values and ranges therebetween). In some embodiments, the length of each of the plurality of tabs 224 may be greater than a corresponding width of each of the plurality of tabs 224. In some embodiments, the peripheral length of each of the plurality of tabs 224 may be less than a corresponding width of each of the plurality of tabs 224. In some embodiments, a ratio of the length to the width of each of the plurality of tabs 224 may be in a range of about 10:1 to about 0.5:1, inclusive (e.g., about 10:1, about 9:1, about 8:1, about 7:1, about 6:1, about 5:1, about 4.5:1, about 4:1, about 3.5:1, about 3:1, about 2.5:1, about 2:1, about 1.5:1, about 1:1, or about 0.5:1, inclusive of all values and ranges therebetween).

In some embodiments, each of the plurality of tabs 224 may be configured to apply a biasing force on a stack (e.g., the stack 110) that may be in a range of about 0.1 lbs. to about 50 lbs., inclusive (e.g., about 0.1, about 0.5, about 1.0, about 1.5, about 2.0, about 2.5, about 3.0, about 3.5, about 4.0, about 4.5, about 5.0, about 10, about 15, about 20, about 25, about 30, about 35, about 40, about 45, or about 50 lbs., inclusive of all values and ranges therebetween). In some embodiments, the compliance member 220 may be configured to exert a pressure in a range of about 1.0 psi to about 100.0 psi, inclusive on the stack (e.g., about 1.0, about 2.0, about 2.5, about 3.0, about 3.5, about 4.0, about 4.5, about 5.0, about 6.0, about 7.0, about 8,0, about 9.0, about 10.0, about 11.0, about 12.0, about 13.0, about 14.0, about 15.0, about 20, about 25, about 30, about 35 about 40, about 45, about 50, about 60, about 70, about, 80, about 90, or about 100 psi, inclusive of all values and ranges therebetween) irrespective of the number of tabs 224 included in the compliance member 220.

In some embodiments, the pressure exerted by the compliance member 220 is at least about 1.0 psi. In some embodiments, the pressure exerted by the compliance member 220 is at least about 2.0 psi. In some embodiments, the pressure exerted by the compliance member 220 is at least about 2.5 psi. In some embodiments, the pressure exerted by the compliance member 220 is at least about 3.0 psi. In some embodiments, the pressure exerted by the compliance member 220 is at least about 3.5 psi. In some embodiments, the pressure exerted by the compliance member 220 is at least about 4.0 psi. In some embodiments, the pressure exerted by the compliance member 220 is at least about 4.5 psi. In some embodiments, the pressure exerted by the compliance member 220 is at least about 5.0 psi. In some embodiments, the pressure exerted by the compliance member 220 is at least about 6.0 psi. In some embodiments, the pressure exerted by the compliance member 220 is at least about 7.0 psi. In some embodiments, the pressure exerted by the compliance member 220 is at least about 8.0 psi. In some embodiments, the pressure exerted by the compliance member 220 is at least about 9.0 psi. In some embodiments, the pressure exerted by the compliance member 220 is at least about 11.0 psi. In some embodiments, the pressure exerted by the compliance member 220 is at least about 12.0 psi. In some embodiments, the pressure exerted by the compliance member 120 is at least about 15.0 psi. In some embodiments, the pressure exerted by the compliance member 120 is at least about 20.0 psi. In some embodiments, the pressure exerted by the compliance member 120 is at least about 30.0 psi. In some embodiments, the pressure exerted by the compliance member 120 is at least about 40.0 psi. In some embodiments, the pressure exerted by the compliance member 120 is at least about 50.0 psi.

In some embodiments, the pressure exerted by the compliance member 220 is at most about 100.0 psi. In some embodiments, the pressure exerted by the compliance member 220 is at most about 90.0 psi. In some embodiments, the pressure exerted by the compliance member 220 is at most about 80.0 psi. In some embodiments, the pressure exerted by the compliance member 220 is at most about 70.0 psi. In some embodiments, the pressure exerted by the compliance member 220 is at most about 60.0 psi. In some embodiments, the pressure exerted by the compliance member 220 is at most about 50.0 psi. In some embodiments, the pressure exerted by the compliance member 220 is at most about 40.0 psi. In some embodiments, the pressure exerted by the compliance member 220 is at most about 30.0 psi. In some embodiments, the pressure exerted by the compliance member 220 is at most about 25.0 psi. In some embodiments, the pressure exerted by the compliance member 220 is at most about 20.0 psi. In some embodiments, the pressure exerted by the compliance member 220 is at most about 15.0 psi.

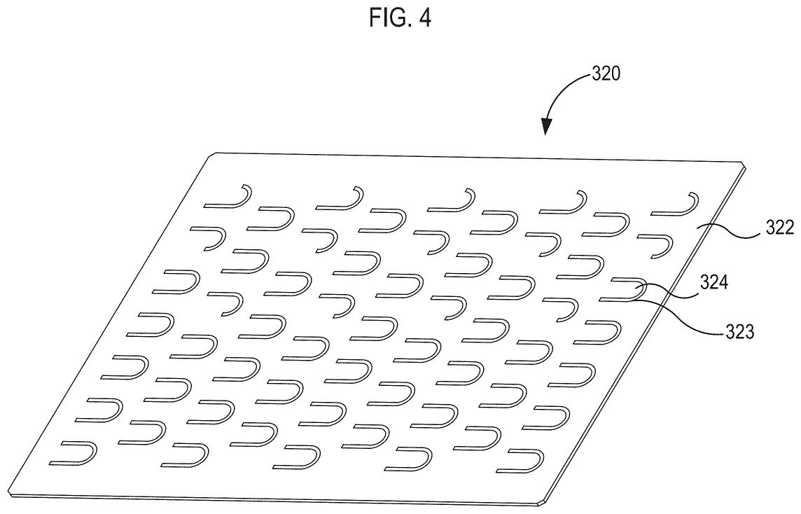

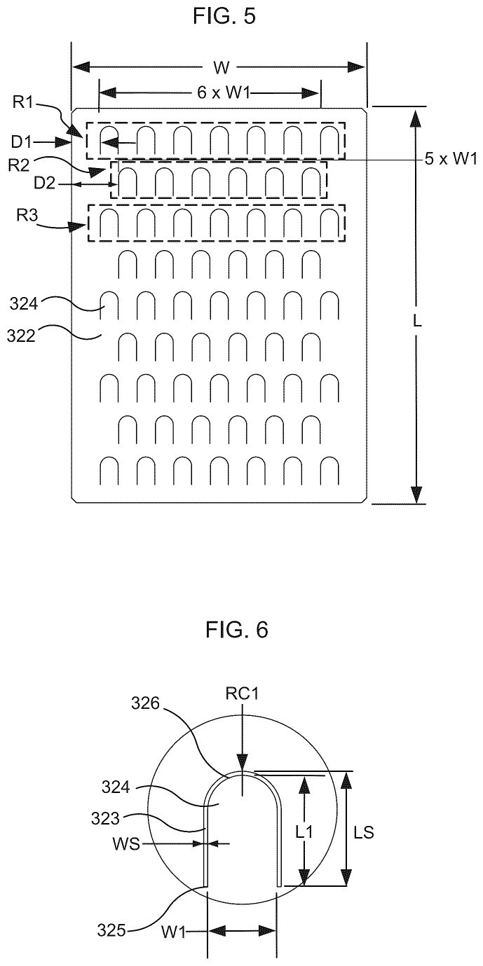

FIG. 4 is a top perspective view of a compliance member 320 including a base 322 in a first configuration in which a plurality tabs 324 of the compliance member 320 are not yet bent for functioning as biasing member to apply a biasing force on a stack, according to an embodiment. FIG. 5 is a top view of the compliance member 320 of FIG. 4, and FIG. 6 is a top view of a single tab 324 included in the compliance member of FIGS. 4-5.

Expanding further, the base 322 includes a substantially flat plate configured to be disposed proximate to an outermost electrochemical cell included in a stack (e.g., the electrochemical cell 110a included in the stack 110). In some embodiments, the compliance member 320, the base 322, and/or the tabs 324 may be substantially similar to the compliance member 120, the base 122, and/or the tabs 124, respectively, as described with respect to FIG. 1A. Therefore, certain features of the compliance member 320, the base 322, and/or the tabs 324 are not described in further detail herein. The edges of the base 322 may smoothened and the corners thereof rounded so as to facilitate insertion into the housing (e.g., housing 102) and prevent damage to electrochemical cells included in an electrochemical cell stack (e.g., stack 110) because of the base 322 sliding across a corresponding electrochemical cell in the stack, or otherwise contacting the electrochemical cell.

In some embodiments, a length L of the base 322 may be in a range of about 0 mm to about 2,000 mm, inclusive (e.g., about 10, about 20, about 30, about 40, about 50, about 100, about 150, about 160, about 170, about 180, about 190, about 200, about 205, about 210, about 215, about 220, about 225, about 230, about 235, about 240, about 245, about 250, about 260, about 270, about 280, about 290, about 300 mm, about 400, about 500, about 600, about 700, about 800, about 900, about 1,000, about 1,200, about 1,400, about 1,600, about 1,800, or about 2,000 mm, inclusive of all values and ranges therebetween). In some embodiments, a width W of the base 322 may be in a range of about 10.0 mm to about 2,000 mm, inclusive (e.g., about 10, about 20, about 30, about 40, about 50, about 100, about 100, about 110, about 120, about 130, about 140, about 150, about 160, about 170, about 180, about 190, about 200 mm, about 205, about 210, about 215, about 220, about 225, about 230, about 235, about 240, about 245, about 250, about 260, about 270, about 280, about 290, about 300 mm, about 400, about 500, about 600, about 700, about 800, about 900, about 1,000, about 1,200, about 1,400, about 1,600, about 1,800, or about 2,000 mm, inclusive of all values and ranges therebetween). In some embodiments a ratio of the length L to the width W (L:W) of the base 322 may be in range of about 20:1 to about 1:1, inclusive (e.g., about 20:1, about 15:1, about 10:1, about 9:1, about 8:1, about 7:1, about 6:1, about 5:1, about 4:1, about 3:1, about 2:1, about 1.9:1, about 1.8:1, about 1.7:1, about 1.6:1, about 1.5:1, about 1.4:1, about 1.3:1, about 1.2:1, about 1.1:1, or about 1:1, inclusive of all values and ranges therebetween).

A plurality of slots 323 are defined through the base 322 corresponding to a peripheral edge of the plurality of tabs 324 with a first end of each of the plurality of tabs 324 remaining attached to the base 322. In some embodiments, the slots 323 may be substantially similar to the slots 223 as described with respect to FIG. 3A, and, therefore, certain features of the slots 323 are not described in further detail herein. The slots 323 may be formed using cutting (e.g., water jet cutting, laser cutting, thermal cutting, etc.), stamping (e.g., die stamping or cutting), any other suitable method or a combination thereof. In some embodiments, a width WS of each of the slots 323 as shown in FIG. 6 may be in a range of about 0.1 mm to about 5 mm, inclusive (e.g., about 0.1 mm, about 0.2 mm, about 0.3 mm, about 0.4 mm, about 0.5 mm, about 0.6 mm, about 0.7 mm, about 0.8 mm, about 0.9 mm, about 1.0 mm, about 1.2 mm, about 1.4 mm, about 1.6 mm, about 1.8 mm, about 2.0 mm, about 2.5 mm, about 3.0 mm, about 3.5 mm, about 4.0 mm, about 4.5 mm, or about 5.0 mm, inclusive of all values and ranges therebetween). In some embodiments, an axial length LS of each of the slots 323 may be in a range of about 3 mm to about 60 mm, inclusive (e.g., about 3, about 4, about 5, about 6, about 7, about 8, about 9, about 10, about 11, about 12, about 13, about 14, about 15, about 16, about 17, about 18, about 19, about 20, about 25, about 30, about 35, about 40, about 45, about 50, about 55, or about 60 mm, inclusive of all values and ranges therebetween).

The number of tabs 324 included in the compliance member 320 as well as a spacing therebetween may be varied to control an amount of biasing force applied by each of the plurality of tabs 324 on the base 322. In some embodiments, a first row R1 of the plurality of tabs 324 may include an odd number of tabs 324, for example, seven tabs 324, a second row R2 of the plurality of tabs 124 adjacent to the first row R1 may include an even number of tabs 324, for example, six tabs 324, a third row R3 of the plurality of tabs 324 adjacent to the second row R2 may include an odd number of tabs 324, for example, seven tabs 324, and so on as shown in FIG. 5. In some embodiments, the compliance member 320 may include 59 tabs. In some embodiments, a width W1 of each of the plurality of tabs 324 may be in a range of about 1 mm to about 25 mm, inclusive (e.g., about 1, about 2, about 3, about 4, about 5, about 6, about 7, about 8, about 9, about 10 mm, about 15, about 20, or about 25 mm, inclusive). In some embodiments, a length L1 of each of the plurality of tabs 324 as shown in FIG. 6 may be in a range of about 3 mm to about 50 mm, inclusive (e.g., about 3, about 4, about 5, about 6, about 7, about 8, about 9, about 10, about 11, about 12, about 13, about 14, about 15, about 16, about 17, about 18, about 19,about 20, about 25, about 30, about 35, about 40, about 45, or about 50 mm, inclusive of all values and ranges therebetween). In some embodiments, the length L1 of each of the plurality of tabs 324 may be greater than a corresponding width W1 of each of the plurality of tabs 324. In some embodiments, the length L1 of each of the plurality of tabs 324 may be less than a corresponding width W1 of each of the plurality of tabs 324. In some embodiments, a ratio of the length L1 to the width W1 of each of the plurality of tabs 324 may be in a range of about 10:1 to about 0.5:1, inclusive (e.g., about 10:1, about 9:1, about 8:1, about 7:1, about 6:1, about 5:1, about 4.5:1, about 4:1, about 3.5:1, about 3:1, about 2.5:1, about 2:1, about 1.5:1, about 1:1, or about 0.5:1, inclusive of all values and ranges therebetween).

In some embodiments, a spacing between an outer peripheral edge of a first tab 324 included in a row having odd number of tabs 324 (e.g., the first row R1) and an inner peripheral edge of the last tab 324 in the same row may be about 6×W1 of each of the tabs 324. Moreover, a first distance D1 between the outer peripheral edge of the first tab 324 (or the last tab 324) in the odd numbered rows and a corresponding outer edge of the base 322 may be in a range of about 3 mm to about 80 mm, inclusive (e.g., about 3, about 5, about 10, about 20, about 30, about 40, about 50, about 60, about 70, or about 80 mm, inclusive of all values and ranges therebetween). In some embodiments, a spacing between an outer peripheral edge of a first tab 324 included in a row having even number of tabs 324 (e.g., the second row R2) and an inner peripheral edge of the last tab 324 in the same row may be about 5×W1 of each of the tabs 324. Moreover, a second distance D2 between the outer peripheral edge of the first tab 324 (or the last tab 324) in the even numbered rows and a corresponding outer edge of the base 322 may be in a range of about 3 mm to about 120 mm, inclusive (e.g., about 3, about 5, about 10, about 20, about 30, about 40, about 50, about 60, about 70, about 80, about 90, about 100, about 110, or about 120 mm, inclusive of all values and ranges therebetween). In some embodiments, a ratio between the second distance D2 and the first distance D1 (D2:D1) may be in range of about 10:1 to about 2:1 (e.g., about 10:1, about 9:1, about 8:1, about 7:1, about 6:1, about 5:1, about 4.5:1, about 4:1, about 3.5:1, about 3:1, about 2.5:1, or about 2:1, inclusive of all values and ranges therebetween).

As shown in in FIGS. 4-6, a second end 326 of each of the plurality of tabs 324, which is free and located opposite the first end 325 of each of the plurality of tabs 324, is rounded so as to define a radius of curvature RC1. In some embodiments, the radius of curvature RC1 may be in a range of about 1 mm to about 25 mm, inclusive (e.g., about 1, about 2, about 3, about 4, about 5, about 6, about 7, about 8, about 9, about 10, about 15, about 20, or about 25 mm, inclusive of all values and ranges therebetween). In some embodiments, the radius of curvature RC1 may be at least about 1 mm. In some embodiments, the radius of curvature RC1 may be at least about 2 mm. In some embodiments, the radius of curvature RC1 may be at least about 3 mm. In some embodiments, the radius of curvature RC1 may be at least about 4 mm. In some embodiments, the radius of curvature RC1 may be at least about 5 mm. In some embodiments, the radius of curvature RC1 may be at least about 6 mm. In some embodiments, the radius of curvature RC1 may be at least about 7 mm. In some embodiments, the radius of curvature RC1 may be at least about 8 mm. In some embodiments, the radius of curvature RC1 may be at least about 10 mm. In some embodiments, the radius of curvature RC1 may be at least about 15 mm. In some embodiments, the radius of curvature RC1 may be at least about 20 mm.

In some embodiments, the radius of curvature RC1 may be at most about 25 mm. In some embodiments, the radius of curvature RC1 may be at most about 20 mm. In some embodiments, the radius of curvature RC1 may be at most about 15 mm. In some embodiments, the radius of curvature RC1 may be at most about 10 mm. In some embodiments, the radius of curvature RC1 may be at most about 9 mm. In some embodiments, the radius of curvature RC1 may be at most about 8 mm. In some embodiments, the radius of curvature RC1 may be at most about 7 mm. In some embodiments, the radius of curvature RC1 may be at most about 6 mm. Various combinations and subcombinations of the aforementioned ranges are contemplated (e.g., a radius of curvature RC1 at least 1 mm and not more than 25 mm, or at least 5 mm and not more than 20 mm), and should be considered to be within the scope of this disclosure.

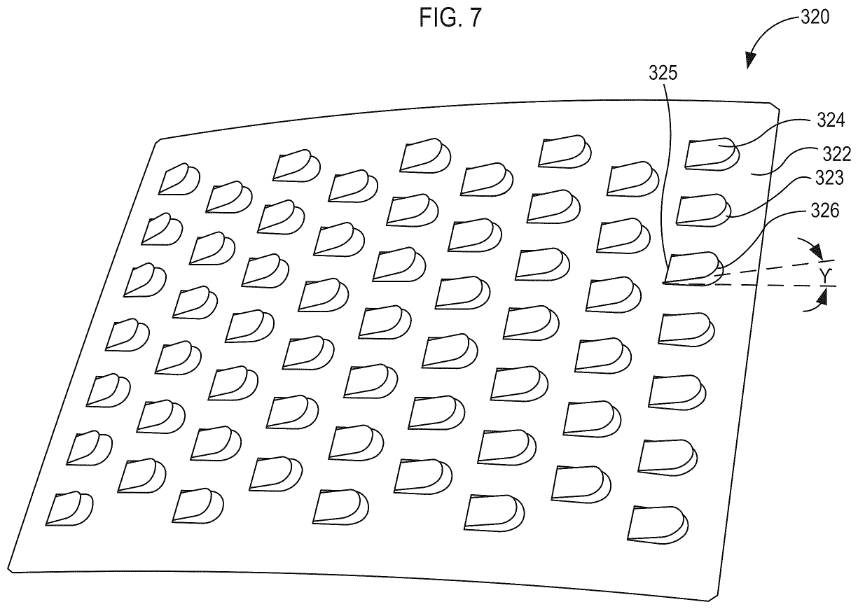

FIG. 7 is a top perspective view of the compliance member 320 of FIG. 4 in a second configuration in which the plurality of tabs 324 are bent about the first end 325 at an angle γ away from the base 322, for example, in a range of about 5 degrees to about 70 degrees, inclusive (e.g., about 5, about 10, about 15, about 20, about 25, about 30, about 35, about 40, about 45, about 50, about 55, about 60, about 65, or about 70 degrees, inclusive of all values and ranges therebetween). For example, in some embodiments, the base 322, and, thereby, the tabs 324, may be formed from steel, stainless steel, metals, or alloys, that is heat treated after bending the tabs 324 such that the tabs 324 are in a relaxed state at the non-zero angle orientation, but resist being bent in a direction towards the base 322.

Thus, each of the plurality of tabs 324 are inclined about the first end at the angle γ away from the base 322 and configured to exert a biasing force on the base 322 in response to being bent towards the base 322. In other words, each of the plurality of tabs 324 acts like a spring biasing the base 324 towards a stack (e.g., the stack 110) in a housing (e.g., the housing 102) in which the stack is disposed and thereby, compressing the stack. In some embodiments, each of the plurality of tabs 324 may be configured to apply a biasing force in a range of about 0.1 lbs. to about 50 lbs., inclusive (e.g., about 0.1, about 0.5, about 1, about 1.5, about 2.0, about 2.5, about 3.0, about 3.5, about 4.0, about 4.5, about 5.0, about 10, about 15, about 20, about 25, about 30, about 35, about 40, about 45, or about 50 lbs., inclusive). In some embodiments, the compliance member 320 may be configured to exert a pressure in a range of about 1.0 psi to about 100.0 psi, inclusive on the stack (e.g., about 1.0, about 2.0, about 2.5, about 3.0, about 3.5, about 4.0, about 4.5, about 5.0, about 6.0, about 7.0, about 8.0, about 9.0, about 10.0, about 11.0, about 12.0, about 13.0, about 14.0, about 15.0, about 20, about 30, about 40, about 50, about 60, about 70, about 80, about 90, or about 100 psi, inclusive of all values and ranges therebetween) irrespective of the number of tabs 324 included in the compliance member 320.

In some embodiments, the pressure exerted by the compliance member 320 is at least about 1.0 psi. In some embodiments, the pressure exerted by the compliance member 320 is at least about 2.0 psi. In some embodiments, the pressure exerted by the compliance member 320 is at least about 2.5 psi. In some embodiments, the pressure exerted by the compliance member 320 is at least about 3.0 psi. In some embodiments, the pressure exerted by the compliance member 320 is at least about 3.5 psi. In some embodiments, the pressure exerted by the compliance member 320 is at least about 4.0 psi. In some embodiments, the pressure exerted by the compliance member 320 is at least about 4.5 psi. In some embodiments, the pressure exerted by the compliance member 320 is at least about 5.0 psi. In some embodiments, the pressure exerted by the compliance member 320 is at least about 6.0 psi. In some embodiments, the pressure exerted by the compliance member 320 is at least about 7.0 psi. In some embodiments, the pressure exerted by the compliance member 320 is at least about 8.0 psi. In some embodiments, the pressure exerted by the compliance member 320 is at least about 9.0 psi. In some embodiments, the pressure exerted by the compliance member 320 is at least about 10.0 psi. In some embodiments, the pressure exerted by the compliance member 320 is at least about 11.0 psi. In some embodiments, the pressure exerted by the compliance member 320 is at least about 12.0 psi. In some embodiments, the pressure exerted by the compliance member 120 is at least about 15.0 psi. In some embodiments, the pressure exerted by the compliance member 120 is at least about 20.0 psi. In some embodiments, the pressure exerted by the compliance member 120 is at least about 30.0 psi. In some embodiments, the pressure exerted by the compliance member 120 is at least about 40.0 psi. In some embodiments, the pressure exerted by the compliance member 120 is at least about 50.0 psi.

In some embodiments, the pressure exerted by the compliance member 320 is at most about 100.0 psi. In some embodiments, the pressure exerted by the compliance member 320 is at most about 90.0 psi. In some embodiments, the pressure exerted by the compliance member 320 is at most about 80.0 psi. In some embodiments, the pressure exerted by the compliance member 320 is at most about 70.0 psi. In some embodiments, the pressure exerted by the compliance member 320 is at most about 60.0 psi. In some embodiments, the pressure exerted by the compliance member 320 is at most about 50.0 psi. In some embodiments, the pressure exerted by the compliance member 320 is at most about 40.0 psi. In some embodiments, the pressure exerted by the compliance member 320 is at most about 30.0 psi. In some embodiments, the pressure exerted by the compliance member 320 is at most about 20.0 psi. In some embodiments, the pressure exerted by the compliance member 320 is at most about 10.0 psi. In some embodiments, the pressure exerted by the compliance member 320 is at most about 5.0 psi.

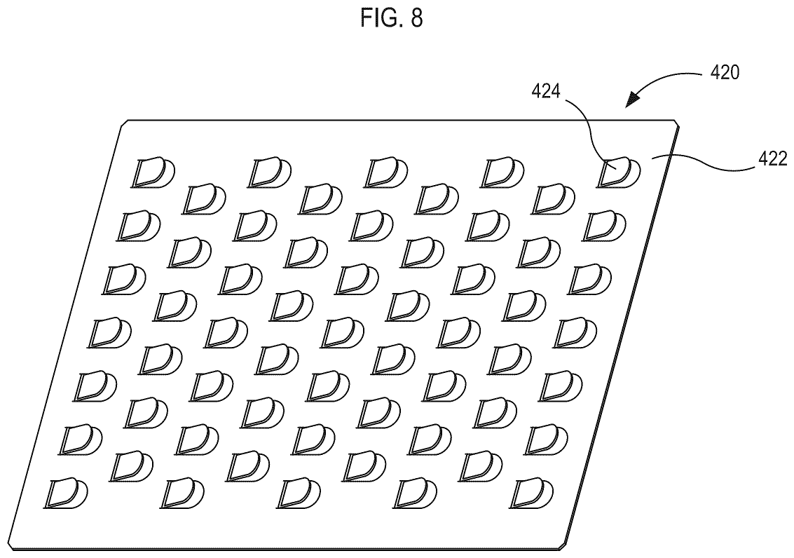

As previously described, the amount of biasing force exerted by the compliance member 320 may depend on the number of tabs 324, the size of the tabs 324, the amount of bending being experienced by the tabs 324, and/or the size of the base 322. For example, FIGS. 8, 9, and 10 are top perspective views of compliance members 420, 520, and 620, each including a base 422, 522, 622, and a plurality of tabs 424, 524, 624, respectively, according to various embodiments. In some embodiments, certain features of each of the compliance members 420, 520, 620, the bases 422, 522, 622, and/or the tabs 424, 524, 624, may be substantially similar to the compliance members 120, 220, 320, the bases 122, 222, 322, and/or the tabs 124, 224, 324, respectively, as described herein with respect to FIGS. 1A, FIG. 2, FIGS. 3A-3B, FIG. 4, FIG. 5, FIG. 6, and/or FIG. 7. Therefore, certain features of the compliance members 420, 520, and 620, the bases 422, 522, 622, and/or the tabs 424, 524, 624 are not described in further detail herein.

As shown in FIG. 8, the compliance member 420 has the base 422 having a first length and first width that has 59 tabs 424 extending at a non-zero angle (e.g., non-zero angles as described herein, for example, with respect to FIG. 1A) away from the base 422. Each tab is configured to exert a force of about 3.0 lbs. on the base 422, and the base 422 is configured to exert a constant pressure of about 3.5 psi on the stack.

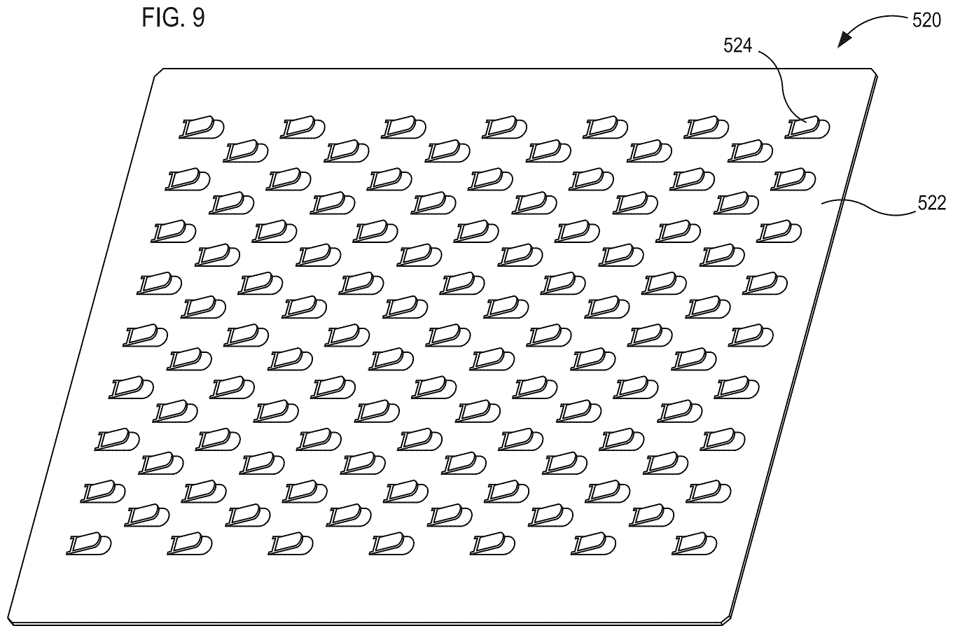

As shown in FIG. 9, the compliance member 520 includes the base 522 that has a second length and a second width that is about equal to the first length and the first width of the base 422 of FIG. 8. The compliance member 520 includes 111 tabs 524 extending at a non-zero angle (e.g., non-zero angles as described herein, for example, with respect to FIG. 1A) away from the base 522, with each tab 524 having a width that is less than a corresponding width of each of the tabs 424 such that each tab 524 is configured to exert a force of about 1.6 lbs. on the base 522, and the base 522 is configured to exert a constant pressure of about 3.5 psi on the stack.

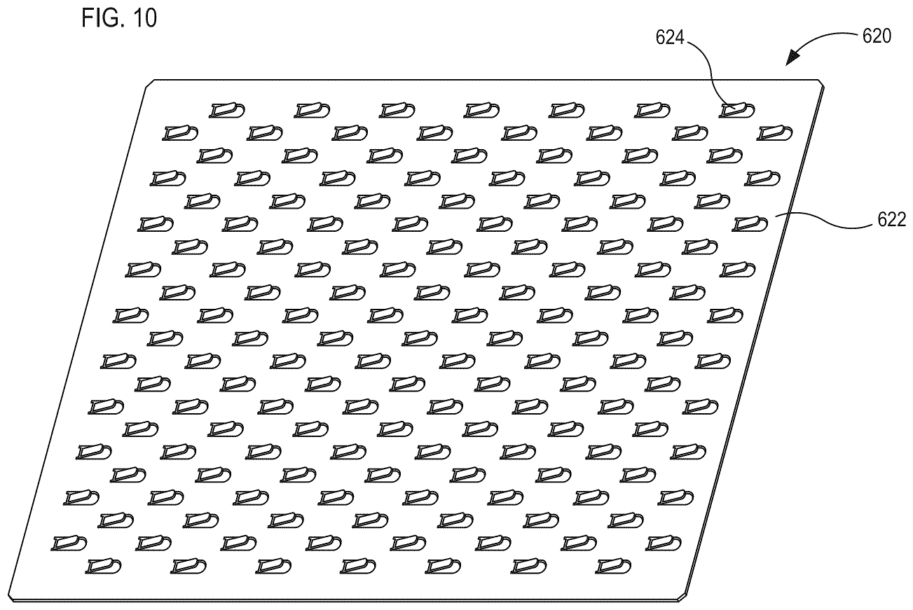

As shown in FIG. 10, the compliance member 620 also includes the base 622 that has a third length and a third width that is about equal to the first length and the first width of the base 422 of the compliance member 420 of FIG. 8, and, therefore, also the second length and the second width of the base 522 of the compliance member 520 of FIG. 9. The compliance member 620 includes 157 tabs 624 extending at a non-zero angle (e.g., non-zero angles as described herein, for example, with respect to FIG. 1A) away from the base 622, with each tab 624 having widths that are less than corresponding widths of the tabs 524 such that each tab 524 is configured to exert a force of about 1.1 lbs. on the base 622, and the base 622 is configured to exert a constant pressure of about 3.5 psi on the stack.

Thus, by increasing the number of tabs in the compliance member while keeping the size of the base the same, a peak biasing force exerted by each tab (e.g., any of tabs 124, 224, 324, 424, 524, 624 as described herein) may be reduced while still collectively providing the desired pressure on the base (e.g., any of bases 122, 222, 322, 422, 522, 622 as described herein) of the compliance member (e.g., any of compliance members 120, 220, 320, 420, 520, 620 as described herein). This may increase the life of each of the tabs, and, therefore, an operational life of the compliance member.

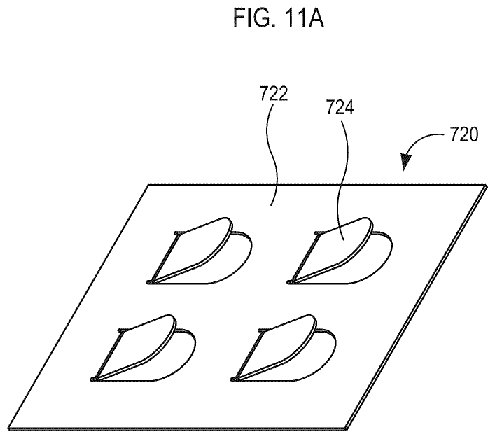

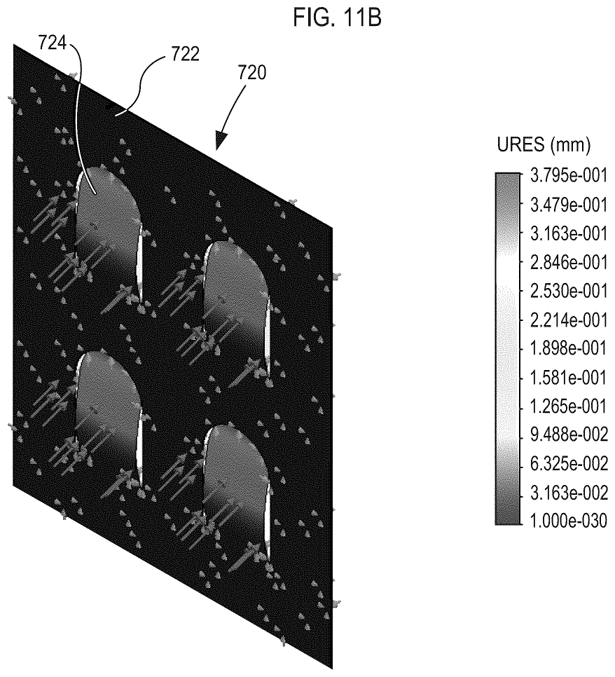

FIG. 11A is a top perspective view of a compliance member 720 that includes a base 722 and four tabs 724 extending from the base at a non-zero angle, according to an embodiment. The base 722 and the tabs 724 may be substantially similar to the base 322 and the tabs 324, previously described herein. FIG. 11B are results from the FEA performed on the compliance member 720 in response to a 4 lbs. distributed load applied on each tab 724. As observed in the FEA model, the 4 lbs. load on each tab results in an equivalent force of about 236 lbs. on the compliance member 720 if it included 59 tabs, and that results in a pressure of about 4.7 psi being applied by the base 722 on a corresponding stack.

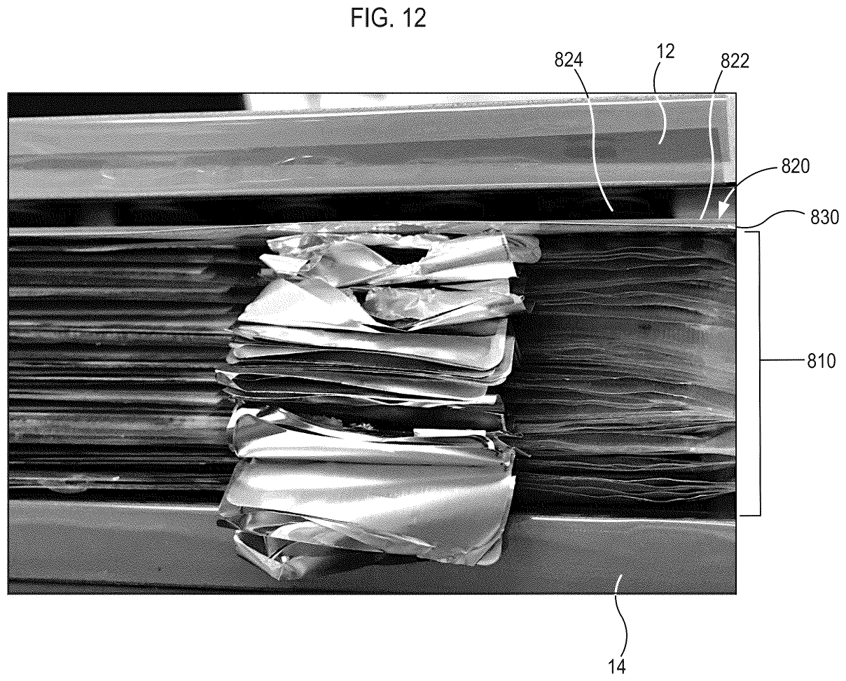

FIG. 12 is an image of an electrochemical cell stack 810 (hereinafter “stack 810”) being secured between a first clamping plate 12 and a second clamping plate 14, and the compliance member 820 being disposed between the stack 810 and the first clamping plate 12. An interface sheet 830 formed from polyethylene terephthalate (PET) and having a thickness of about 0.25 mm is interposed between the stack 810 and the compliance member 820. The compliance member 820 includes a base 822 and a plurality of tabs 824. In some embodiments, the stack 810, the compliance member 820, the base 822, the tabs 824, and/or the interface sheet 830, or certain features thereof, may be substantially similar to the stack 110, the compliance members 120, 320, the bases 122, 322, the tabs 124, 324, and/or the interface sheet 130, respectively, as described herein with respect to FIGS. 1A, 4, 5, 6, and/or 7. Therefore, certain features of the stack 810, the compliance member 820, the base 822, the tabs 824, and/or the interface sheet 830 are not described in further detail herein.

The total number of tabs 824 included in the compliance member 820 is 59. The compliance member 820 was formed from non-heat treated steel, i.e., no heat treatment is performed on the compliance member 820 after tabs 824 were bent away from the base 822 to be oriented at a desired angle. The plates 12 and 14 are configured to compress the stack 810 and the compliance member 820 disposed therebetween such that a distance between the clamping plates 12 and 14 is about 36.5 mm that mimics a width of an internal volume of an example housing in which the stack 810 may be disposed.

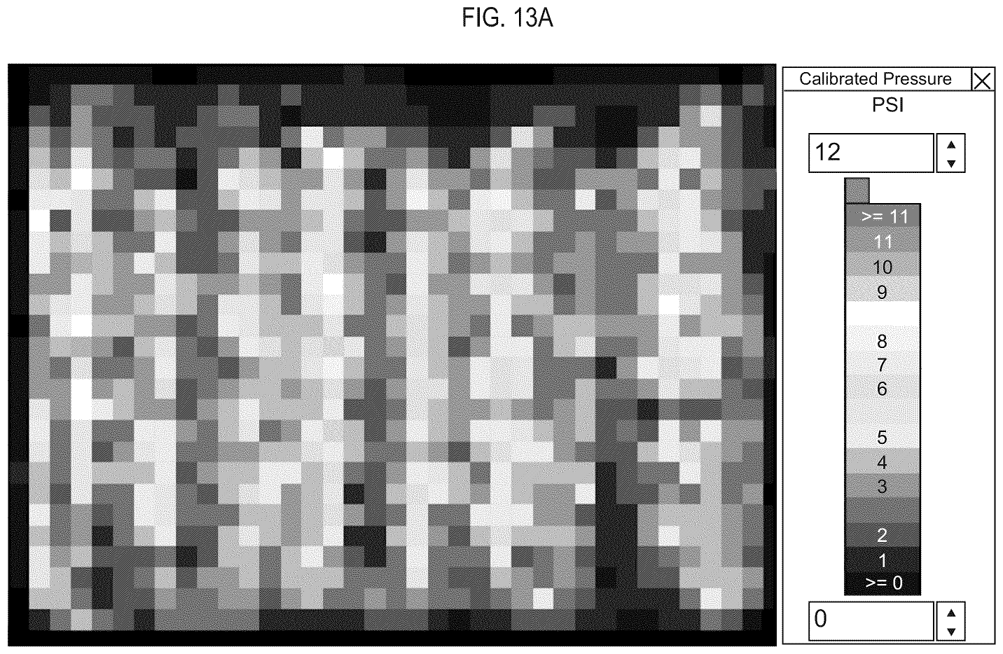

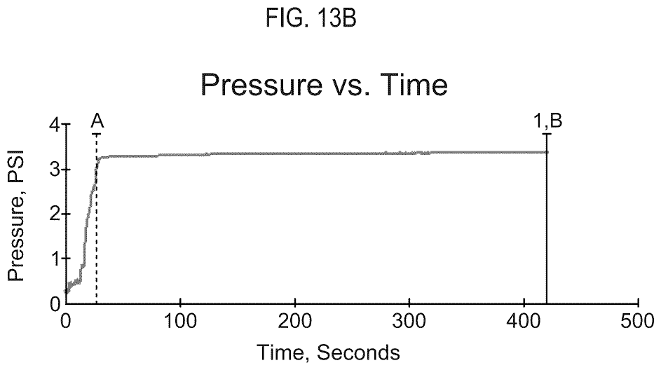

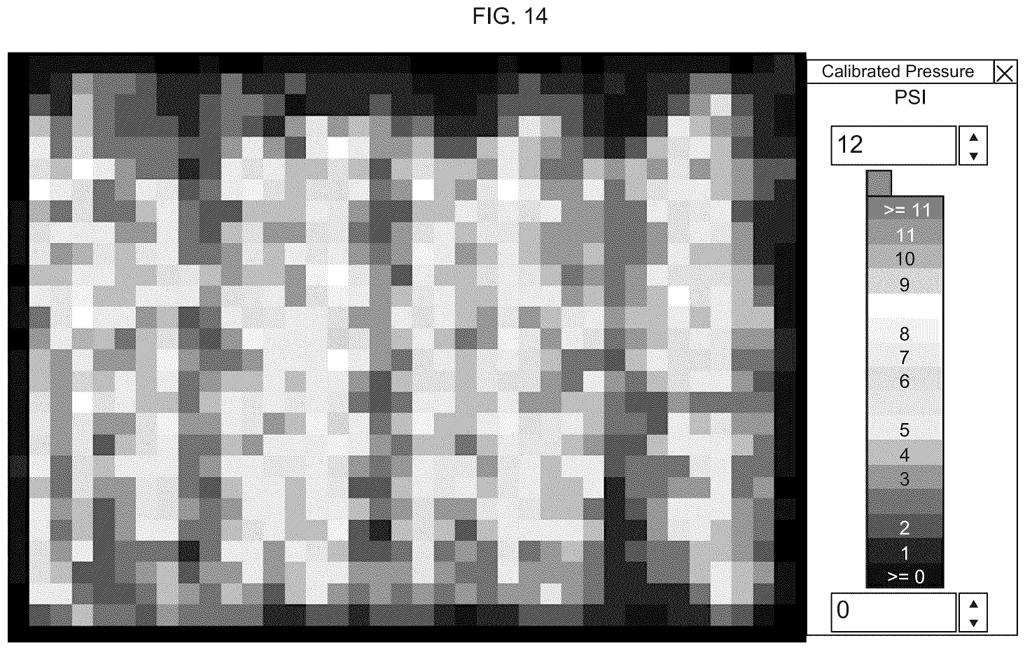

FIG. 13A illustrates a force distribution on the base 822 of the compliance member 820 of FIG. 12 due to the biasing force exerted by the biasing members 824 at an initial time after compression of the stack 810 by the clamping plates 12 and 14, and FIG. 13B is a plot of pressure exerted by the base 822 of compliance member 820 on the stack 810 over a period of 400 seconds. As the clamping plates 12 and 14 start compressing the compliance member 820 and thereby, the stack 810 within about 25 seconds the clamping plates are spaced apart by a distance of about 36.5 mm. As shown in FIG. 13B, the compliance member 820 applies a constant pressure of about 3.20 psi for about 400 seconds after initial compression is complete (e.g., between time A and time B, i.e., starting at about 25 seconds and ending at about 425 seconds). FIG. 14 illustrates force distribution on the base 822 of the compliance member 820 at a time period of 45 hours after the compliance member 820 is clamped between the stack 810 and the one of the clamping plates 12 or 14. Even after 45 hours, the base 822 of the compliance member 820 exerts an average pressure of about 3.64 psi on the stack 810 demonstrating the feasibility of the compliance member 820 and other compliance members (e.g., compliance members 120, 220, 320, 420, 520, 620, 720) described herein for compressing a stack (e.g., stack 110, 810) disposed in a housing (e.g., housing 102) over long periods of time.

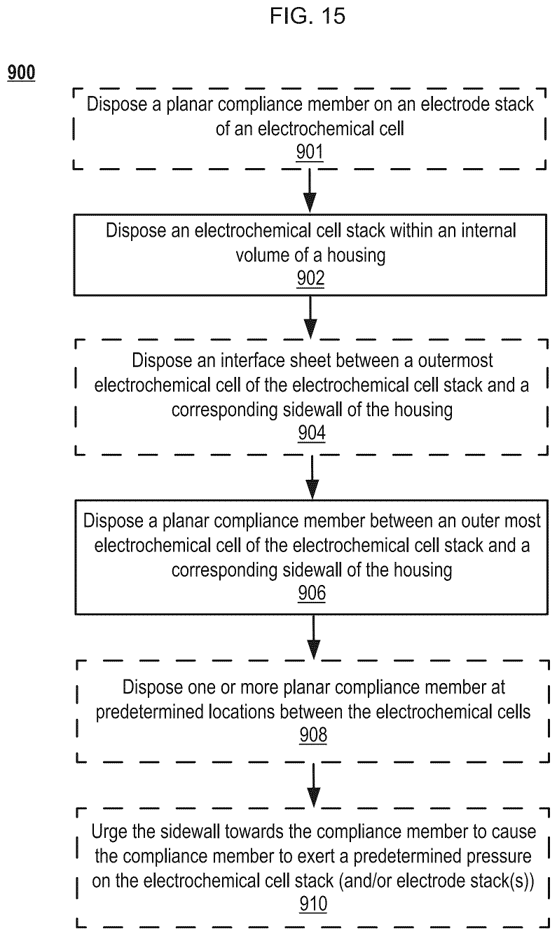

FIG. 15 is a schematic flow chart of a method 900 for exerting a compressive force on an electrochemical cell stack (e.g., the stack 110, 810) disposed in a housing (e.g., the housing 102) via a compliance member (e.g., the compliance member 120, 220, 320, 420, 520, 620, 720, 820), according to an embodiment. While described with respect to the stack 110, the housing 102, and the compliance member 120, the method 900 is equally applicable to, and may be performed with, any stack, housing, or compliance member described herein. All such variations should be considered to be within the scope of this disclosure

The method 900 includes disposing an electrochemical cell stack within an internal volume of a housing, at 902. For example, the stack 110 including the plurality of electrochemical cells 110a-110n are disposed in the internal volume 105 of the housing 102, as previously described herein. The electrochemical cells included in the stack may be in an uncompressed state, as previously described herein. In some embodiments, electrolyte is added to the plurality of electrochemical cells before insertion into the internal volume of the housing 102. In some embodiments, prior to disposing the electrochemical cell stack 110 in the housing 102, the compliance member 120a or any other compliance member described herein may be disposed on an electrode stack included in at least a portion of the electrochemical cells 110a-110n included in the electrochemical cell stack 110, at 901, as previously described herein.

In some embodiments, an interface sheet is disposed between an outermost electrochemical cell of the electrochemical cell stack and corresponding sidewall of the housing, at 904. For example, the interface sheet 130 is inserted between the outermost electrochemical cell 110a and the second sidewall 104 of the housing 102, as previously described herein. At 906, a planar compliance member is disposed between the outermost electrochemical cell 110a of the stack 110 and the corresponding sidewall of the housing. For example, the compliance member 120 is inserted or slid into the housing 102 so as to slide between the outermost electrochemical cell 110a and the second sidewall 104 and disposed therebetween. This causes each of the plurality of tabs 124 of the compliance member 120 to bend about their respective first ends towards the base 122 and exert a biasing force on the base 122 causing the base to exert the compressive pressure on the stack 110, as previously described. In some embodiments, in which the interface sheet 130 is used, the compliance member is disposed between the interface sheet 130 and the stack 110. In some embodiments, the compliance member 120 and the interface sheet 130 may be inserted together into the housing 102 in a single operation. In some embodiments, only the planar compliance member(s) 120a disposed on the electrode stack of at least a portion of the electrochemical cells 110a-110n is used, and the compliance member 120 (i.e., operation 906) may be excluded.

In some embodiments, in addition, or alternatively, to operation 906, one or more compliance members 120 are disposed at predetermined locations between the electrochemical cells 110a-110n (e.g., between each electrochemical cell included in the stack 110, between every 2 electrochemical cells included in the stack 110, between every 3 electrochemical cells included in the stack 110, or any suitable configuration), at 908, as previously described herein. In some embodiments, the second sidewall 104 of the housing 102, or any other suitable sidewall of the housing 102 is urged towards the compliance member 120 (or the stack 110) to cause the compliance member 120 to exert a predetermined pressure on the electrochemical cell stack 110 and/or the electrode stack(s), at 910, as previously described herein.

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

In addition, the disclosure may include other innovations not presently described. Applicant reserves all rights in such innovations, including the right to embodiment such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein may be implemented in a manner that enables a great deal of flexibility and customization as described herein.

All definitions, as defined and used herein, should be understood to control over dictionary definitions, definitions in documents incorporated by reference, and/or ordinary meanings of the defined terms.

As used herein, in particular embodiments, the terms “about” or “approximately” when preceding a numerical value indicates the value plus or minus a range of 10%. Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

While specific embodiments of the present disclosure have been outlined above, many alternatives, modifications, and variations will be apparent to those skilled in the art. Accordingly, the embodiments set forth herein are intended to be illustrative, not limiting. Various changes may be made without departing from the spirit and scope of the disclosure. Where methods and steps described above indicate certain events occurring in a certain order, those of ordinary skill in the art having the benefit of this disclosure would recognize that the ordering of certain steps may be modified and such modification are in accordance with the variations of the invention. Additionally, certain of the steps may be performed concurrently in a parallel process when possible, as well as performed sequentially as described above. The embodiments have been particularly shown and described, but it will be understood that various changes in form and details may be made.

1. An assembly, comprising:
a housing defining an internal volume;
an electrochemical cell stack including a plurality of electrochemical cells disposed in the internal volume; and
a compliance member disposed in the internal volume, the compliance member including:
a base, and
a plurality of biasing members extending away from a surface of the base, the plurality of biasing members configured to cause a biasing force to be exerted on the electrochemical cell stack so as to compress the electrochemical cell stack.

2. The assembly of claim 1, wherein the plurality of biasing members are disposed between the electrochemical cell stack and a sidewall of the housing.

3. The assembly of claim 2, wherein the plurality of biasing members extend from a surface of the base towards the sidewall of the housing, each of the plurality of biasing members configured to exert the biasing force on the base to cause the base to exert a compressive pressure on the electrochemical cell stack.

4. The assembly of claim 3, wherein each of the plurality of biasing members is configured to apply a biasing force in a range of about 0.1 lb to about 50.0 lbs on the base.

5. The assembly of claim 4, wherein the base is configured to exert a pressure in a range of about 1 psi to about 100 psi on the electrochemical cell stack.

6. The assembly of claim 2, wherein the base is substantially planar.

7. The assembly of claim 2, further comprising an interface sheet disposed between the compliance member and the electrochemical cell stack.

8. The assembly of claim 2, wherein each of the plurality of biasing members include a tab having a first end coupled to the surface of the base and a second end located distal from the first end and the base such that each of the plurality of tabs are inclined at non-zero angle away from the base.

9. The assembly of claim 8, wherein the non-zero angle is in a range of about 5 degrees to about 70 degrees.

10. The assembly of claim 8, wherein:
the base includes a plurality of slots defined through the base such that the first end of each tab of the plurality of tabs is coupled to the base and a peripheral edge of each tab of the plurality of tabs is disconnected from the base; and
each of the plurality of tabs is inclined about the first end at the non-zero angle away from the base and is configured to exert a biasing force on the base in response to being bent towards the base.

11. The assembly of claim 10, wherein the second end of the each of the plurality of tabs is rounded.

12. The assembly of claim 2, wherein each of the plurality of biasing members includes a tab having a first end coupled to the surface of the base, a second end located distal from the first end and the base, and a ridge formed at a location between the first end the second end such that each of the plurality of tabs extends at a first non-zero angle from the first end to the ridge away from the base, and extends at a second non-zero angle from the ridge towards the base.

13. An assembly, comprising:
a housing defining an internal volume;
an electrochemical cell stack including a plurality of electrochemical cells disposed in the internal volume, each of the plurality of electrochemical cells including a cathode and an anode, at least one of the cathode or the anode being semi-solid; and
a compliance member disposed in the internal volume, the compliance member configured to exert a biasing force on the electrochemical cell stack causing the electrochemical cell stack to transition from an uncompressed configuration before the compliance member is disposed in the internal volume to a compressed state after the compliance member is disposed in the internal volume.

14. The assembly of claim 13, wherein the compliance member includes a base and a plurality of tabs defined in the base.

15. The assembly of claim 14, wherein each of the plurality of tabs extends from the base at a non-zero angle relative to the base.

16. The assembly of claim 14, wherein the plurality of tabs includes about 3 tabs to about 10,000 tabs.

17. The assembly of claim 13, wherein the biasing force is in a range of about 0.1 lb to about 50 lbs.

18. An assembly, comprising:
a housing defining an internal volume;
an electrochemical cell including one or more electrodes disposed in the internal volume; and
a compliance member disposed in the internal volume, the compliance member including:
a base, and
a plurality of biasing members extending away from a surface of the base, the plurality of biasing members configured to cause a biasing force on the one or more electrodes to compress the one or more electrodes.

19. The assembly of claim 18, wherein the electrochemical cell is prismatic.

20. The assembly of claim 18, wherein each of the plurality of biasing members includes a tab having a first end coupled to a surface of the base and a second end located distal from the first end and the base.

21. The assembly of claim 18, further comprising:
a ridge formed at a location between the first end and the second end of each tab such that each tab includes a first portion extending at a first non-zero angle relative to the base, and a second portion extending at a second non-zero angle relative to the base, the second non-zero angle different from the first non-zero angle.

22. The assembly of claim 21, wherein the first portion is defined between the first end to the ridge such that the first non-zero angle is away from the base.

23. The assembly of claim 21, wherein the second portion is defined between the ridge and the second end such that the second non-zero angle is towards the base.

24. A method, comprising:
disposing an electrochemical cell stack including a plurality of electrochemical cells within an internal volume of a housing, each of the plurality of electrochemical cells including a first electrode, a second electrode, and a separator therebetween;
disposing a compliance member between an outermost electrochemical cell of the electrochemical cell stack and a sidewall of the housing, the compliance member including a base, and a plurality of biasing members coupled to the base, each of the plurality of biasing members configured to exert a biasing force on the base such that the base exerts a pressure on the electrochemical cell stack; and
compressing the electrochemical cell stack, via the compliance member, from a first thickness to a second thickness less than the first thickness.

25. The method of claim 24, wherein at least one of the first electrode or the second electrode is a semi-solid electrode including an active material and a liquid electrolyte.

26. The method of claim 25, wherein the active material and the liquid electrolyte are mixed to form the semi-solid electrode prior to disposing the electrochemical cell stack within the internal volume of the housing.
